(19) United States
(12) Patent Application Publication
(10) Pub. No.: US 2024/0249928 A1
(43) Pub. Date: Jul. 25, 2024

(54) MASS SPECTROMETRY IMAGE PROCESSING METHOD, IMAGE PROCESSING METHOD AND MASS SPECTROMETRY APPARATUS

(71) Applicant: SHIMADZU CORPORATION, Kyoto-shi (JP)

(72) Inventor: Makoto SATO, Kyoto-shi (JP)

(21) Appl. No.: 18/413,929

(22) Filed: Jan. 16, 2024

(30) Foreign Application Priority Data
Jan. 20, 2023 (JP) 2023-007433

(51) Int. Cl. H01J 49/00; G06T 5/50

(52) U.S. Cl. CPC H01J 49/0004; G06T 5/50; H01J 49/0036; G06T 2207/20182

(57) ABSTRACT

A mass spectrometry image processing method according to this invention includes a step of acquiring a mass spectrometry image that is generated based on mass spectrometry data of a subject; a step of acquiring an optical image that is generated by imaging the subject; and a step of generating a high-resolution mass spectrometry image that is generated based on pixel values of the optical image, which has the higher resolution, and pixel values of the mass spectrometry image, which has a lower resolution, to improve the resolution of the mass spectrometry image, wherein the step of generating the high-resolution mass spectrometry image includes adjusting a variation of each pixel value of the mass spectrometry image.

### CROSS-REFERENCE TO RELATED APPLICATIONS

The related application number JP2023-007433, mass spectrometry image processing method, image processing method and mass spectrometry apparatus, Jan. 20, 2023, SATO Makoto upon which this patent application is based are hereby incorporated by reference.

### BACKGROUND OF THE INVENTION

### Field of the Invention

The present invention relates to a mass spectrometry image processing method, an image processing method and a mass spectrometry apparatus, in particular to a mass spectrometry image processing method, an image processing method and a mass spectrometry apparatus capable of improving resolution.

### Description of the Background Art

Mass spectrometry image processing methods for improving resolution are known in the art. Such a mass spectrometry image processing method is disclosed in United States patent application publication No. US2015/0131888, for example.

A molecular imaging system disclosed in the aforementioned United States patent application publication No. US2015/0131888 includes a microscope, an imaging mass spectrometry apparatus, a microscope feature extractor, an imaging mass spectrometry apparatus feature extractor, and a modeling component. The modeling component disclosed in the aforementioned United States patent application publication No. US2015/0131888 is configured to improve resolution of images acquired by the imaging mass spectrometry apparatus based on parameters of chromaticity extracted by the microscope feature extractor and parameters of spectral peaks extracted by the imaging mass spectrometry apparatus extractor. In other words, the configuration disclosed in the aforementioned United States patent application publication No. US2015/0131888 generates high-resolution mass spectrometry images based on high-resolution microscopic images and low-resolution mass spectrometry images. In the configuration disclosed in the aforementioned United States patent application publication No. US2015/0131888, pixel values of a mass spectrometry image whose resolution has been improved are compared with pixel values of the mass spectrometry image before the improvement of its resolution so that pixel values of a mass spectrometry image whose resolution has been improved are brought close to the pixel values of the mass spectrometry image before the improvement of its resolution.

In a case in which a concentration of a compound to be measured included in a subject is low, its mass spectrometry image includes many superimposed noises, and as a result it is often difficult to distinguish between the compound to be measured and the noises. However, in the configuration disclosed in the aforementioned United States patent application publication No. US2015/013188, when a mass spectrometry image whose resolution is improved (high-resolution mass spectrometry images) is generated based on a high-resolution microscopic image (optical image) and a low-resolution mass spectrometry image, pixel values of the high-resolution microscopic image are brought closer to pixel values of the mass spectrometry image before the improvement of its resolution. For this reason, in a case in which the mass spectrometry image before the improvement of its resolution includes many superimposed noises, for example, the high-resolution mass spectrometry image also includes many superimposed noises. Accordingly, such noises deteriorate visibility in the high-resolution mass spectrometry image. In this case, it can be conceived that the noises superimposed on the high-resolution are reduced by reducing the noises in the mass spectrometry image based on weighted averages of pixel values of pixels located in proximity to each other. However, if the noises superimposed on the mass spectrometry image are reduced based on the weighted averages of pixel values of pixels located in proximity to each other, the mass spectrometry image becomes blurred. Such a blurred mass spectrometry image reduces visibility of the compound to be measured in the high-resolution mass spectrometry image. In other words, if the noises superimposed on the mass spectrometry image is reduced, contrarily, it can be difficult for users to grasp a distribution of the compound to be measured in the high-resolution mass spectrometry image. Consequently, a technology that can appropriately adjust a noise amount while improving resolution in generation of a high-resolution mass spectrometry image is desired.

### SUMMARY OF THE INVENTION

The present invention is intended to solve the above problem, and one object of the present invention is to provide a mass spectrometry image processing method, an image processing method and a mass spectrometry apparatus capable of adjusting a noise amount while improving resolution in generation of a high-resolution mass spectrometry image, which has an improved resolution, based on a low-resolution mass spectrometry image and a high-resolution optical image.

In order to attain the aforementioned object, a mass spectrometry image processing method according to a first aspect of the present invention includes a step of acquiring a mass spectrometry image that is generated based on mass spectrometry data of a subject; a step of acquiring an optical image that is generated by imaging the subject, the optical image having a higher resolution than the mass spectrometry image; and a step of generating a high-resolution mass spectrometry image that is generated based on pixel values of the optical image, which has the higher resolution, and pixel values of the mass spectrometry image, which has a lower resolution, to improve the resolution of the mass spectrometry image, wherein the step of generating the high-resolution mass spectrometry image includes adjusting a variation of each pixel value of the mass spectrometry image. In this specification, the term “adjustment of a variation amount of each pixel value of the mass spectrometry image” means that a variation amount of each pixel value of the mass spectrometry image is adjusted to an allowable degree. Also, in this specification, the term “high(er) resolution” means that a high(er) number of pixels included in an image. Also, in this specification, the term “low(er) resolution” means that a low(er) number of pixels included in an image.

An image processing method according to a second aspect of the present invention includes a step of acquiring a first image; a step of acquiring a second image that has a higher resolution than the first image; and a step of generating a third high-resolution image that is generated based on pixel values of the second image, which has the higher resolution, and pixel values of the first image, which has a lower resolution, to improve the resolution of the mass spectrometry image, wherein in the step of generating the third image, adjustment of a variation amount of each pixel value of the first image is executed.

A mass spectrometry apparatus according to a third aspect of this invention includes a mass spectrometry image acquirer configured to acquire a mass spectrometry image that is generated based on mass spectrometry data of a subject; an optical image acquirer configured to acquire an optical image that is generated by imaging the subject, the optical image having a higher resolution than the mass spectrometry image; and an image processor configured to generate a high-resolution mass spectrometry image that is generated based on pixel values of the optical image, which has the higher resolution, and pixel values of the mass spectrometry image, which has a lower resolution, to improve the resolution of the mass spectrometry image, wherein the image processor is configured to adjust a variation amount of each pixel value of the mass spectrometry image when generating the high-resolution mass spectrometry image.

A mass spectrometry image processing method according to a fourth aspect of the present invention includes a step of acquiring a mass spectrometry image that is generated based on mass spectrometry data of a subject; a step of acquiring an optical image that is generated by imaging the subject, the optical image having a higher resolution than the mass spectrometry image; and a step of generating an intermediate image based on the optical image; a step of generating a high-resolution mass spectrometry image that is generated based on the optical image, which has the higher resolution, the intermediate image, and the mass spectrometry image, which has a lower resolution, to improve the resolution of the mass spectrometry image, wherein in the step of generating the high-resolution mass spectrometry image a step of generating the high-resolution mass spectrometry image based on the intermediate image and a coefficient matrix, which is a matrix of a plurality of coefficients, and a step of updating the coefficient matrix to reduce differences between the pixel values of the high-resolution mass spectrometry image and the pixel values of the mass spectrometry image are repeatedly executed to optimize the coefficient matrix, and the high-resolution mass spectrometry image is generated based on the optimized coefficient matrix and the intermediate image.

In the mass spectrometry image processing method according to the aforementioned first aspect of the present invention, and the mass spectrometry apparatus according to the aforementioned third aspect, as discussed above, when the high-resolution mass spectrometry image is generated based on the optical image, which has the higher resolution, and the mass spectrometry image, which has a lower resolution, to improve the resolution of the mass spectrometry image, a variation amount of each pixel value of the mass spectrometry image is adjusted. Accordingly, when the high-resolution mass spectrometry image is generated based on the mass spectrometry image, which includes superimposed noises, an amount of the superimposed noises included in the high-resolution mass spectrometry image can be appropriately adjusted by adjusting a variation amount of each pixel value of the mass spectrometry image. Therefore, it is possible to adjust a noise amount while improving resolution in generation of a high-resolution mass spectrometry image, which has an improved resolution, based on a low-resolution mass spectrometry image and a high-resolution optical image.

In the image processing method according to the aforementioned second aspect, when a third high-resolution image is generated based on pixel values of the second image, which has the higher resolution, and pixel values of the first image, which has a lower resolution, adjustment of a variation amount of each pixel value of the first image is executed. Accordingly, similar to the mass spectrometry image processing method according to the aforementioned first aspect, it is possible to provide an image processing method capable of adjusting a noise amount while improving resolution in generation of a high-resolution third image based on a low-resolution first image and a high-resolution second image.

In the mass spectrometry image processing method according to the aforementioned fourth aspect, a step of generating an intermediate image based on the optical image; and a step of generating a high-resolution mass spectrometry image that is generated based on the optical image, which has the higher resolution, the intermediate image, and the mass spectrometry image, which has a lower resolution, to improve the resolution of the mass spectrometry image are provided, wherein in the step of generating the high-resolution mass spectrometry image a step of generating the high-resolution mass spectrometry image based on the intermediate image and a coefficient matrix, which is a matrix of a plurality of coefficients, and a step of updating the coefficient matrix to reduce differences between the pixel values of the high-resolution mass spectrometry image and the pixel values of the mass spectrometry image are repeatedly executed to optimize the coefficient matrix, and the high-resolution mass spectrometry image is generated based on the optimized coefficient matrix and the intermediate image.

Here, in a case in which a high-resolution mass spectrometry image is generated based on an intermediate image and a single coefficient (scalar coefficient), the number of coefficients become smaller relative to the number of pixels of the mass spectrometry image. In this case, a system for determining coefficients becomes an overdetermined system including more equations than unknowns. In overdetermined systems, they generally have no solution so that locally some pixels whose pixel values cannot acquire will appear in the high-resolution mass spectrometry image generated based on the mass spectrometry image. In this case, contrast of the high-resolution mass spectrometry image is reduced. To address this, the high-resolution mass spectrometry image is generated based on the intermediate image and the coefficient matrix, and as a result the number of coefficients in the coefficient matrix can be equal to the number of pixels in the mass spectrometry image. Accordingly, the pixel values of pixels of the high-resolution mass spectrometry image can be acquired based on the mass spectrometry image by adjusting the coefficients included in the coefficient matrix. Consequently, it is possible to prevent reduction of contrast of the high-resolution mass spectrometry image.

### BRIEF DESCRIPTION OF THE DRAWINGS

FIG. 1 is a block diagram view entirely showing a configuration of a mass spectrometry apparatus according to a first embodiment.

FIG. 2 is a view schematically showing an optical image generated by the mass spectrometry apparatus according to the first embodiment.

FIG. 3 is a view schematically showing a mass spectrometry image generated by the mass spectrometry apparatus according to the first embodiment.

FIG. 4 is a view schematically showing a high-resolution mass spectrometry image generated by the mass spectrometry apparatus according to the first embodiment.

FIG. 5 is a view schematically showing a first enlarged image of the mass spectrometry image.

FIG. 6 is a view schematically showing a second enlarged image of the mass spectrometry image.

FIG. 7 is a schematic diagram illustrating the mass spectrometry apparatus according to the first embodiment that generates a high-resolution mass spectrometry image.

FIG. 8A is a view schematically showing a high-resolution mass spectrometry image.

FIG. 8B is a view schematically showing a high-resolution mass spectrometry image generated by using a first coefficient different from the high-resolution mass spectrometry image shown in FIG. 8A.

FIG. 8C is a view schematically showing a high-resolution mass spectrometry image generated by using a first coefficient different from the high-resolution mass spectrometry image shown in FIGS. 8A and 8B.

FIG. 9 is a flowchart illustrating noise adjustment of a high-resolution mass spectrometry image by the mass spectrometry apparatus according to the first embodiment.

FIG. 10 is a flowchart illustrating generation of a high-resolution mass spectrometry image by the mass spectrometry apparatus according to the first embodiment.

FIG. 11 is a block diagram view entirely showing a configuration of a mass spectrometry apparatus according to a second embodiment.

FIG. 12 is a schematic diagram illustrating the mass spectrometry apparatus according to the second embodiment that generates a high-resolution mass spectrometry image.

FIG. 13 is a view schematically showing an optical, a mass spectrometry image, and a high-resolution mass spectrometry image generated by the mass spectrometry apparatus according to the second embodiment.

FIG. 14 is a flowchart illustrating generation of a high-resolution mass spectrometry image by the mass spectrometry apparatus according to the second embodiment.

FIG. 15 is a block diagram view entirely showing a configuration of a mass spectrometry apparatus according to a modified example of the second embodiment.

FIG. 16 is a flowchart illustrating noise adjustment of a high-resolution mass spectrometry image by the mass spectrometry apparatus according to the modified example of the second embodiment.

### DESCRIPTION OF THE PREFERRED EMBODIMENT

Embodiments embodying the present invention will be described with reference to the drawings.

### First Embodiment

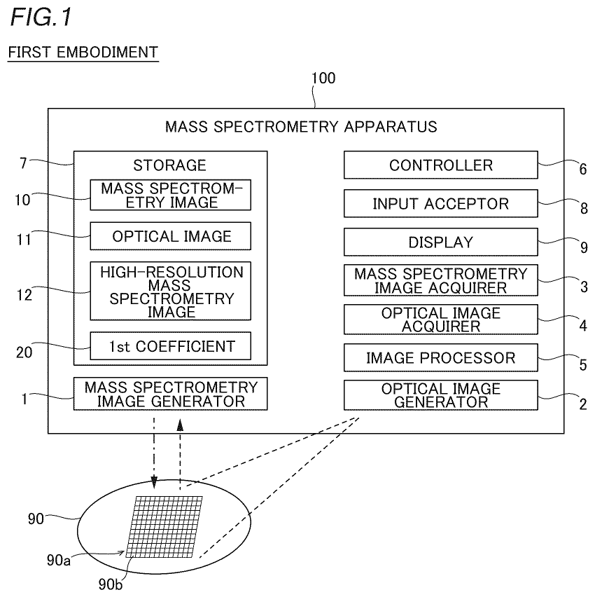

A configuration of a mass spectrometry apparatus 100 (see FIG. 1), and image processing of a mass spectrometry image 10 (see FIG. 1) by the mass spectrometry apparatus 100 according to a first embodiment are now described with reference to FIGS. 1 to 8. The mass spectrometry image 10 is an example of a “first image” in the claims.

### (Configuration of Mass Spectrometry Apparatus)

The mass spectrometry apparatus 100 according to the first embodiment is now described with reference to FIG. 1. The mass spectrometry apparatus 100 is configured to generate a mass spectrometry image 10, for example, to measure a distribution of a sample included in a subject 90 (a compound to be measured included in the subject 90). The subject 90 is an organ of a mouse, etc., for example. In the first embodiment, the subject 90 is a part of a brain of a mouse.

As shown in FIG. 1, the mass spectrometry apparatus 100 includes a mass spectrometry image generator 1, an optical image generator 2, and a mass spectrometry image acquirer 3, an optical image acquirer 4, and an image processor 5. In the first embodiment, the mass spectrometry apparatus 100 includes a controller 6, a storage 7, and an input acceptor 8, and a display 9.

The mass spectrometry image generator 1 is configured to execute mass spectrometry for measurement points 90b in a measurement target area 90a of the subject 90. Also, the mass spectrometry image generator 1 is configured to generate the mass spectrometry image 10 based on mass spectrometry data of the subject 90. The mass spectrometry image generator 1 includes a MALDI (Matrix Assisted Laser Desorption/Ionization) ion source, an ion transport optics, an ion trap, a time-of-flight mass spectrometry device, an ion detector, etc., and is configured to perform mass spectrometry on a very small area having a predetermined size corresponding to the measurement points 90b over a predetermined mass-to-charge ratio range, for example.

The mass spectrometry image generator 1 includes a driver (not shown) that can highly precisely move a stage (not shown) on which the subject 90 is placed in two axis directions in a plane so that the mass spectrometry data (mass spectral data) of an area having any size can be acquired by performing mass spectrometry while moving the subject 90 by a predetermined step width. Also, the mass spectrometry image generator 1 is configured to generate the mass spectrometry image 10 based on the acquired mass spectrometry data.

The optical image generator 2 is configured to generate an optical image 11 of the subject 90 by capturing an image of the subject 90. The optical image generator 2 includes an optical microscope. The optical image generator 2 can generate the optical image 11 including the subject 90 similar to the subject 90 included in the mass spectrometry image 10 by capturing an image of the measurement target area 90a of the subject 90. The optical image 11 is an example of a “second image” in the claims.

The mass spectrometry image acquirer 3 is configured to acquire the mass spectrometry image 10 generated based on the mass spectrometry data of the subject 90. Specifically, the mass spectrometry image acquirer 3 is configured to acquire the mass spectrometry image 10 generated by the mass spectrometry image generator 1. The mass spectrometry image acquirer 3 is an input/output interface, for example.

The optical image acquirer 4 is configured to acquire the optical image 11, which is generated by imaging the subject 90, the optical image having a higher resolution than the mass spectrometry image 10. Specifically, the optical image acquirer 4 is configured to acquire the optical image 11 generated by the optical image generator 2. The optical image acquirer 4 is an input/output interface, for example.

The image processor 5 is configured to generate a high-resolution mass spectrometry image 12 based on pixel values of the optical image 11, which has the higher resolution, and pixel values of the mass spectrometry image 10, which has a lower resolution, to improve the resolution of the mass spectrometry image. The image processor 5 includes a processor such as CPU (Central Processing Unit) or GPU (Graphics Processing Unit), or a FPGA (Field-Programmable Gate Array) or circuitry configured for image processing, etc. A configuration of the image processor 5 that generates the high-resolution mass spectrometry image 12 will be described in detail later. The high-resolution mass spectrometry image 12 is an example of a “third image” in the claims.

The controller 6 is configured to control parts of the mass spectrometry apparatus 100. The controller 6 includes a processor such as a CPU, or circuitry, for example.

The storage 7 is configured to store the mass spectrometry image 10, the optical image 11, and the high-resolution mass spectrometry image 12. In addition, the storage 7 is configured to store a first coefficient 20, which will be described later. The storage 7 includes a nonvolatile storage device such as an HDD (Hard Disk Drive) or e.g., an SSD (Solid State Drive), for example.

The input acceptor 8 is configured to accept operating inputs from a user. The input acceptor 8 includes, for example, a mouse and an input device such as a keyboard.

The display 9 is configured to display at least one of the mass spectrometry image 10, the optical image 11, and the high-resolution mass spectrometry image 12. For example, the display 9 is a display device such as an LCD monitor or an organic EL (Electro Luminescence) monitor.

### (Optical Image, Mass Spectrometry Image, and High-Resolution Mass Spectrometry Image)

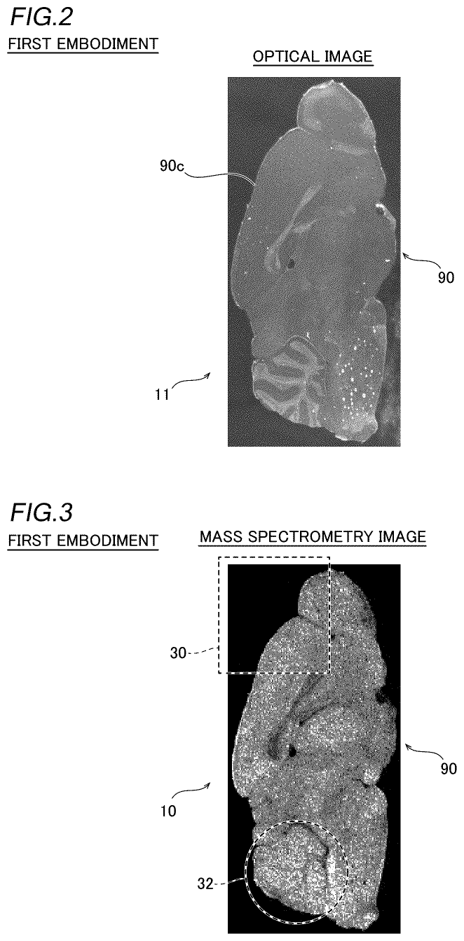

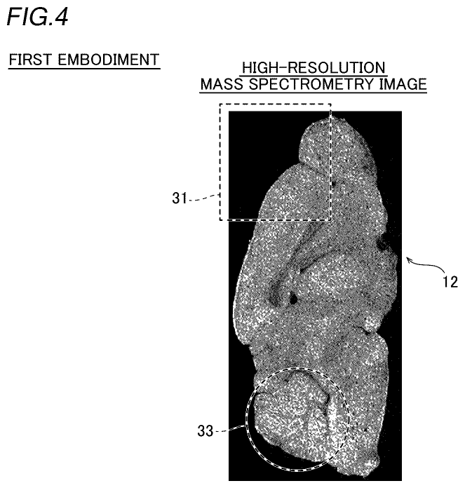

The optical image 11 (see FIG. 2), the mass spectrometry image 10 (see FIG. 3), and the high-resolution mass spectrometry image 12 (see FIG. 4) are now described with reference to FIGS. 2 to 4.

The optical image 11 shown in FIG. 2 is an optical image of the subject 90 captured by the optical image generator 2 (see FIG. 1). In the first embodiment, the optical image 11 includes a slice of the mouse brain as the subject 90. More specifically, the optical image 11 includes a slice of the brain, as the subject 90, after a compound to be measured is given to the mouse.

The mass spectrometry image 10 shown in FIG. 3 is an image of a compound that has a predetermined mass-to-charge ratio (m/z) in the measurement target area 90a (see FIG. 1) of the subject 90. The mass spectrometry image 10 is an image that generated based on intensity signals of the predetermined m/z as the pixel values, and represents that a concentration of the compound is increased as a pixel becomes closer to white. Although a sized of the mass spectrometry image 10 shown in FIG. 3 is shown the same size as the optical image 11 shown in FIG. 2 for convenience, the mass spectrometry image 10 is actually smaller than the optical image 11. In other words, the mass spectrometry image 10 has a lower resolution than the optical image 11.

The high-resolution mass spectrometry image 12 shown in FIG. 4 is a high-resolution mass spectrometry image generated based on the optical image 11 (see FIG. 2) and the mass spectrometry image 10 (see FIG. 3). In the first embodiment, the high-resolution mass spectrometry image 12 has the same resolution as the optical image 11.

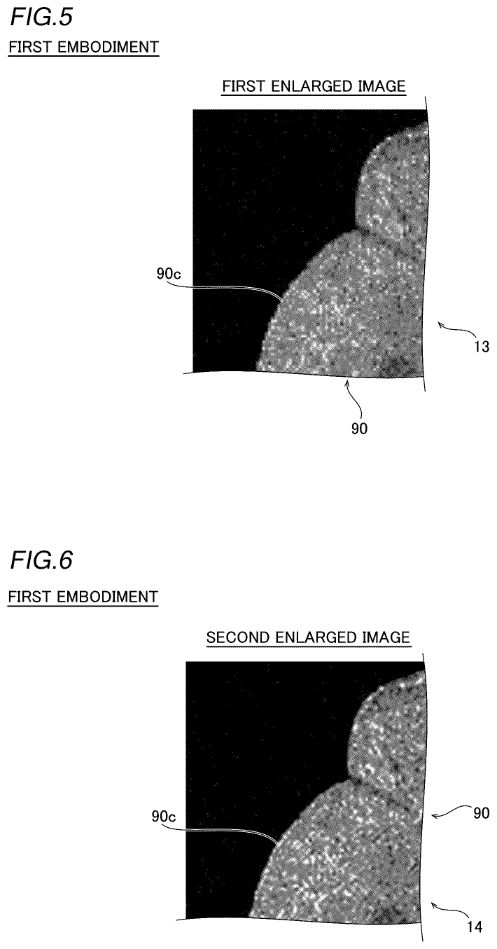

A first enlarged image 13 shown in FIG. 5 is an enlarged image of an area 30 of the mass spectrometry image 10 shown in FIG. 3. Because the resolution of the mass spectrometry image 10 is low, outlines 90c of the subject 90 in the first enlarged image 13 are jagged like stairstep-like lines.

The second enlarged image 14 shown in FIG. 6 is an enlarged image of an area 31 of the high-resolution mass spectrometry image 12 shown in FIG. 4. Because the resolution of the high-resolution mass spectrometry image 12 is higher than the mass spectrometry image 10 (see FIG. 3), outlines 90c of the subject 90 in the second enlarged image 14 are smoother than the outlines 90c of the subject 90 in first enlarged image 13 (see FIG. 5).

Here, a number of white dots are scattered in an area 32 of the mass spectrometry image 10 shown in FIG. 3. It is difficult to determine whether the white dots represent the compound to be measured or noises.

Similar to the area 32 of the mass spectrometry image 10 shown in FIG. 3, a number of white dots are also scattered in an area 33 of the high-resolution mass spectrometry image 12 shown in FIG. 4, and as a result it is difficult to determine whether the white dots represent the compound to be measured or noises.

To address this, in the first embodiment, the image processor 5 (see FIG. 1) is configured to adjust a variation amount of each pixel value of the mass spectrometry image 10 when generating the high-resolution mass spectrometry image 12 (see FIG. 4) based on the optical image 11 (see FIG. 2) and the mass spectrometry image 10 (see FIG. 3). In other words, adjustment of a variation amount of each pixel value of the mass spectrometry image 10 means adjustment of a degree to be allowable variation amount of each pixel value of the mass spectrometry image 10.

### (Generation of High-Resolution Mass Spectrometry Images and Adjustment of Variation Amount of Pixel Values of Mass Spectrometry Image)

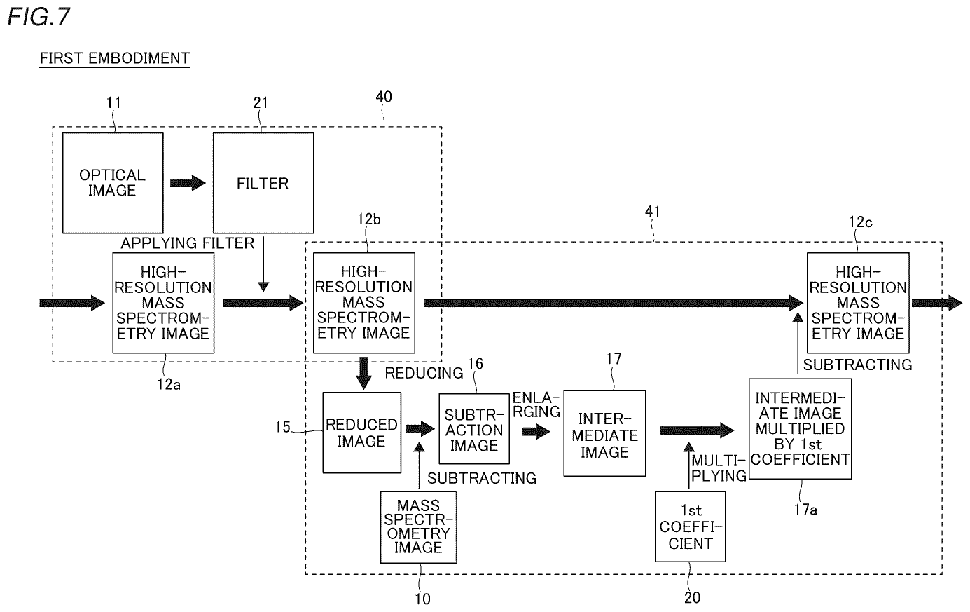

Configurations of the image processor 5 (see FIG. 1) that generates the high-resolution mass spectrometry image 12 (see FIG. 4), and adjusts a variation amount of each pixel value of the mass spectrometry image 10 are now described with reference to FIG. 7.

In the first embodiment, the image processor 5 repeats a process 40 of acquiring and reflecting information on a structure of the optical image 11, and a process 41 of bringing pixel values of the high-resolution mass spectrometry image 12 closer to the pixel values of the mass spectrometry image 10 to generate the high-resolution mass spectrometry image 12.

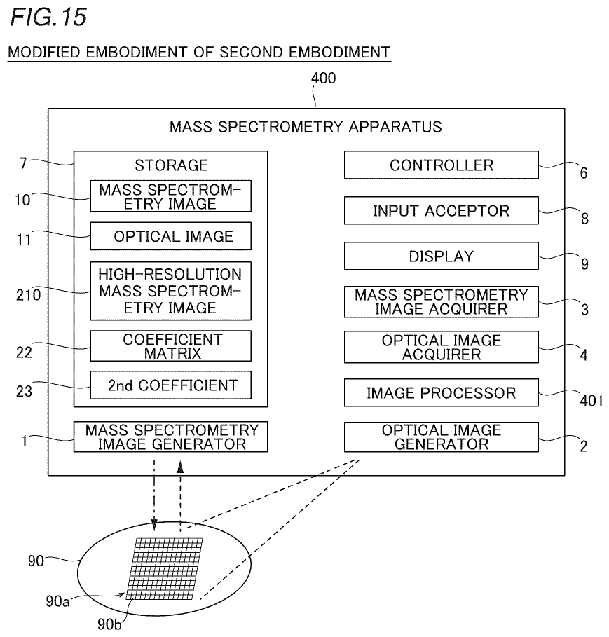

In the first embodiment, the image processor 5 executes adjustment of a variation amount of each pixel value of the mass spectrometry image 10 is executed in the process 41. Specifically, the image processor 5 adjusts the amount of variation of the pixel value of the mass spectrometry image 10 based on coefficients that are previously specified by a user and used to adjust a variation amount of each pixel value of the mass spectrometry image 10. More specifically, the image processor 5 adjusts the amount of variation of the pixel value of the mass spectrometry image 10 based on the coefficients entered by the user. The coefficients include a first coefficient 20 that increases the amount of variation of second pixel values as a value of the first coefficient decreases, or a second coefficient 23 (see FIG. 15) that increases the amount of variation of the second pixel values as a value of the second coefficient increases. In the first embodiment, the coefficients include the first coefficient 20. The first coefficient 20 is greater than 0 (zero) and smaller than 1.

In the first embodiment, the image processor 5 generates a high-resolution mass spectrometry image 12a by enlarging the mass spectrometry image 10 by using known interpolation such as Bilinear, or Bicubic before the process 40 of acquiring and reflecting information on the structure of the optical image 11. Because the high-resolution mass spectrometry image 12a is an enlarged image of the mass spectrometry image 10 enlarged by using known interpolation, the outlines 90c (see FIG. 5) of the subject 90 (see FIG. 5) is unclear. To address this, the image processor 5 sharpens the outlines 90c of the subject 90 included in the high-resolution mass spectrometry image 12a based on information on the outlines 90c (see FIG. 2) of the subject 90 (see FIG. 2) included in the optical image 11 in the process 40. In addition, the image processor 5 sharpens an internal structure of the subject 90 included in the high-resolution mass spectrometry image 12 based on the internal structure of the subject 90 in the optical image 11.

Specifically, the image processor 5 creates a filter 21 by weighting neighborhood similarity of the optical image 11. The image processor 5 applying the created filter 21 on the high-resolution mass spectrometry image 12a to generate a high-resolution mass spectrometry image 12b that reflects the information on the structure of the optical image 11. In other words, the image processor 5 brings the outlines 90c and the internal structure of the subject 90 included in the high-resolution mass spectrometry image 12b closer to the outlines 90c and the internal structure of the subject 90 in the optical image 11 by applying the filter 21 to the high-resolution mass spectrometry image 12a.

Because the outlines 90c of the subject 90 included in the high-resolution mass spectrometry image 12b are brought closer to the outlines 90c of the subject 90 included in the optical image 11 by the process 40, the outlines 90c of the subject 90 included in the high-resolution mass spectrometry image 12b become clearer. However, because the process 40 reflects the pixel values of the optical image 11, the pixel values of the pixels of the high-resolution mass spectrometry image 12b become different from their corresponding pixel values of the mass spectrometry image 10.

To address this, in the first embodiment, the image processor 5 executes the process 41 of bringing the pixel values of the high-resolution mass spectrometry image 12b closer to the pixel values of the mass spectrometry image 10.

In the process 41, the image processor 5 generates an intermediate image 17 based on the optical image 11, the mass spectrometry image 10 and the high-resolution mass spectrometry image 12. The image processor 5 generates a high-resolution mass spectrometry image 12c based on the generated intermediate image 17 and the coefficients.

The intermediate image 17 is generated based on the high-resolution mass spectrometry image 12b. Specifically, in the process 41, the image processor 5 generates a reduced image 15 by reducing the high-resolution mass spectrometry image 12b. The image processor 5 generates the reduced image 15 by reducing the high-resolution mass spectrometry image 12b by using known interpolation so that a resolution of the reduced image 15 becomes equal to the resolution of the mass spectrometry image 10.

Subsequently, the image processor 5 subtracts the mass spectrometry image 10 from the reduced image 15 to generate a subtraction image 16. The image processor 5 then generates the intermediate image 17 by enlarging the subtraction image 16. The image processor 5 generates the intermediate image 17 by known interpolation that enlarges the subtraction image 16. Specifically, the image processor 5 enlarges the subtraction image 16 so that a resolution of the intermediate image 17 becomes equal to the resolution of the high-resolution mass spectrometry image 12b.

Subsequently, the image processor 5 multiplies the intermediate image 17 by the first coefficient 20 to generate an intermediate image 17a. The image processor 5 then generates the high-resolution mass spectrometry image 12c by subtracting the intermediate image 17a, which is multiplied by the first coefficient 20, from the high-resolution mass spectrometry image 12b.

The image processor 5 generates the high-resolution mass spectrometry image 12 by repeating the process 40 and the process 41. In other words, the image processor 5 repeatedly reflects information on the outlines 90c of the subject 90 included in the optical image 11 in the high-resolution mass spectrometry image 12, and repeatedly reduces differences between first pixel values, which are the pixel values of the high-resolution mass spectrometry image 12, and second pixel values, which are the pixel values of the mass spectrometry image 10, to generate the high-resolution mass spectrometry image 12 by repeating the process 40 and the process 41. In the first embodiment, the image processor 5 repeats the process 40 and the process 41 until an amount of change in each pixel value of the high-resolution mass spectrometry image 12 becomes smaller than a threshold. The high-resolution mass spectrometry image 12a to which the filter 21 is applied in the second process 40 or later is the high-resolution mass spectrometry image 12c generated in the process 41.

In the first embodiment, the image processor 5 uses the same value as the first coefficient 20 until generation of the high-resolution mass spectrometry image 12 is completed. If the generated high-resolution mass spectrometry image 12 is not the image desired by the user, the coefficient can be changed by an input instruction from the user. That is, the image processor 5 adjusts the amount of variation of each pixel value of the mass spectrometric image 10 based on the changed first coefficient 20.

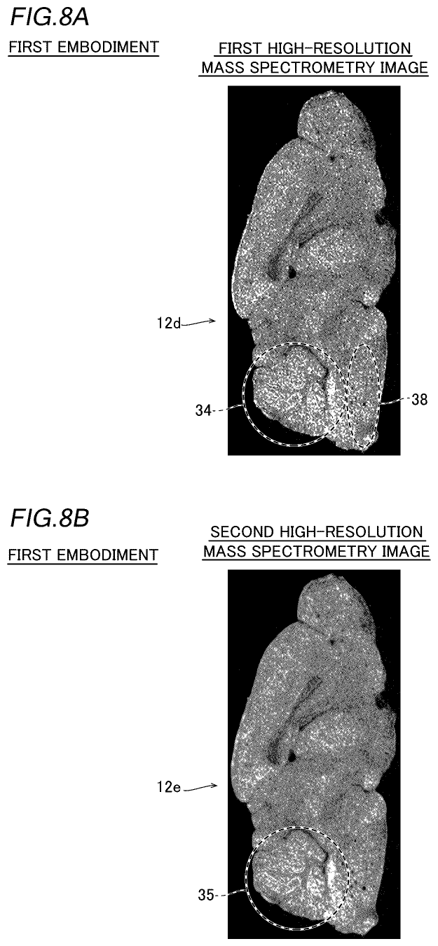

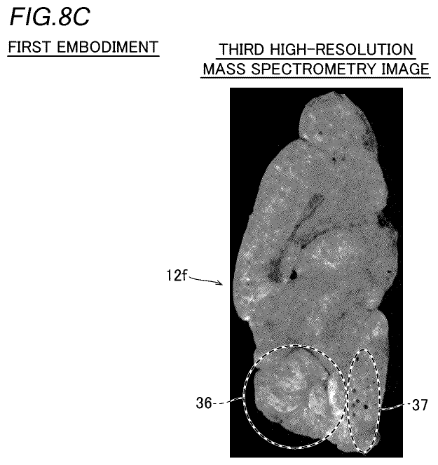

FIGS. 8A to 8C are views showing the first high-resolution mass spectrometry image 12d to the third high-resolution mass spectrometry image 12f generated by changing the first coefficient 20. Values of the first coefficient 20 (see FIG. 7) that are used to generate the first high-resolution mass spectrometry image 12d shown in FIG. 8A, the second high-resolution mass spectrometry image 12e shown in FIG. 8B, and the third high-resolution mass spectrometry image 12f shown in FIG. 8C decrease in this order from the highest value (the first high-resolution mass spectrometry image 12d is generated by using the highest first coefficient 20).

Because an amount of variation of each the pixel value of the mass spectrometry image 10 (see FIG. 3) as an original image decreases with increase of the first coefficient 20, the mass spectrometry image that is generated by using a larger first coefficient has pixel values similar to the mass spectrometry image 10. Contrary to this, because an amount of variation of each the pixel value of the mass spectrometry image 10 increases with decrease of the first coefficient 20, noises superimposed on the mass spectrometry image 10 are reduced by using a lower first coefficient. Because the noises are reduced and a ratio of each pixel value of the mass spectrometry image 10 that reflects the high-resolution mass spectrometry image is also reduced, differences between pixel values of the high-resolution mass spectrometry image 12 that is generated by using a lower first coefficient 20 and pixel values of the mass spectrometry image 10 are larger.

In comparison between an area 34 of the first high-resolution mass spectrometry image 12d, an area 35 of the second high-resolution mass spectrometry image 12e, and an area 36 of the third high-resolution mass spectrometry image 12f, it can be seen that a number of white dots are scattered in the area 34 and distributions of white dots locally appear in the area 35. The area 36 includes not white dots but white parts. Black dots are clearly seen in an area 37 of the third high-resolution mass spectrometry image 12f. Contrary to this, black dots are not clear in the area 38 of the first high-resolution mass spectrometry image 12d. In other words, it cannot be clearly recognized whether the black dots correspond to pixels that have a pixel value of zero or noises in the area 38 of the first high-resolution mass spectrometry image 12d. On the other hand, black dots are clearly seen in the area 37 of the third high-resolution mass spectrometry image 12f. As a result, it can be clearly recognized that the black dots correspond to not noises but pixels that have a pixel value of zero in the area 38.

That is, adjustment of noises and adjustment a ratio of pixel values of the mass spectrometry image 10 that is reflected in the high-resolution mass spectrometry image 12 can be achieved by adjusting the value of the first coefficient 20. Consequently, the user can obtain a desired high-resolution mass spectrometry image 12 by adjusting the value of the first coefficient 20.

### (Noise Adjustment of High-Resolution Mass Spectrometry Image)

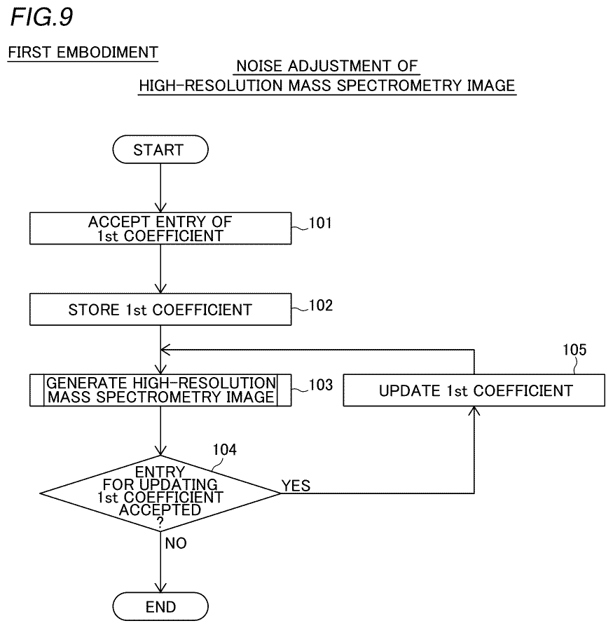

Adjustment of noises in the high-resolution mass spectrometry image 12 (see FIG. 4) by the image processor 5 (see FIG. 1) in the first embodiment is now described with reference to FIG. 9.

In step 101, the controller 6 (see FIG. 1) accepts an entry of the coefficients in accordance with an input instruction from the user. In the first embodiment, the controller 6 accepts the entry of the first coefficient 20 (see FIG. 1).

In step 102, the controller 6 stores the first coefficient 20 into the storage 7 (see FIG. 1).

In step 103, the image processor 5 generates a third image with high resolution based on pixel values of a second image that has a high resolution and pixel values of a first image that has a lower resolution. Specifically, the image processor 5 generates the high-resolution mass spectrometry image 12 that is generated based on pixel values of the optical image 11 (see FIG. 2), which has the higher resolution, and pixel values of the mass spectrometry image 10 (see FIG. 3), which has a lower resolution, to improve the resolution of the mass spectrometry image. In the first embodiment, in step 103, the image processor 5 executes adjustment of a variation amount of each pixel value of the first image. Specifically, the image processor 5 adjusts an amount of variation in each pixel value of the mass spectrometry image 10. In the first embodiment, the image processor 5 adjusts the amount of variation of each pixel value of the mass spectrometric image 10 based on the coefficient entered by the user. Generation of the high-resolution mass spectrometry image 12 and adjustment of a variation amount of each pixel value of the mass spectrometry image 10 by the image processor 5 will be described later.

In step 104, the controller 6 determines whether an entry for updating the coefficient is accepted. Specifically, the controller 6 determines whether an entry for updating the first coefficient 20 is accepted. If no entry for updating the first coefficient 20 is accepted, the procedure ends. If an entry for updating the first coefficient 20 is accepted, the procedure goes to step 105.

In step 105, the controller 6 changes a coefficient that is already entered to the coefficient that is entered by the user. Specifically, the controller 6 updates the first coefficient 20 stored in the storage 7 (see FIG. 1) in accordance with a value entered by the user. Subsequently, the procedure goes to step 103. In step 103 (adjustment of an amount of variation in each pixel value of the mass spectrometry image 10) that follows the change (updating) of the coefficient (first coefficient 20), the image processor 5 adjusts the amount of variation of each pixel value of the mass spectrometry image 10 based on the changed coefficient.

As discussed above, the image processor 5 generates the high-resolution mass spectrometry image 12 based on a desired first coefficient 20 that is entered by the user by executing steps 101 to 105.

### (Generation Process of High-Resolution Mass Spectrometry Image)

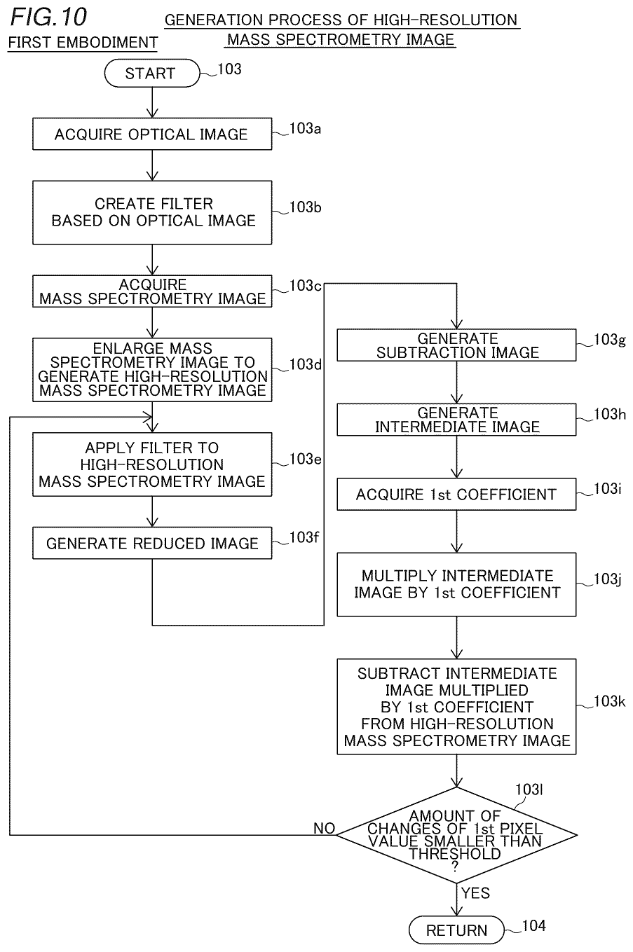

Generation process of the high-resolution mass spectrometry image 12 (see FIG. 4) by the image processor 5 (see FIG. 1) in the first embodiment is now described with reference to FIG. 10.

In step 103a, the optical image acquirer 4 (see FIG. 1) acquires the second image, which has a higher resolution than the first image. Specifically, the optical image acquirer 4 acquires the optical image 11 (see FIG. 2), which is generated by imaging the subject 90, the optical image having a higher resolution than the mass spectrometry image 10 (see FIG. 3).

In step 103b, the image processor 5 creates the filter 21 (see FIG. 7) based on the optical image 11.

In step 103c, the mass spectrometry image acquirer 3 acquires the first image. Specifically, the mass spectrometry image acquirer 3 acquires the mass spectrometry image 10 generated based on the mass spectrometry data of the subject 90.

In step 103d, the image processor 5 enlarges the mass spectrometry image 10 to generate the high-resolution mass spectrometry image 12a (see FIG. 7).

In step 103e, the image processor 5 applies the filter 21 on the high-resolution mass spectrometry image 12a to generate the high-resolution mass spectrometry image 12b.

In step 103f, the image processor 5 generates the reduced image 15 (see FIG. 7) by reducing the high-resolution mass spectrometry image 12b.

In step 103g, the image processor 5 generates the subtraction image 16 (see FIG. 7) by subtracting the mass spectrometry image 10 from the reduced image 15.

In step 103h, the image processor 5 generates the intermediate image 17 (see FIG. 7) by enlarging the subtraction image 16. In other words, the image processor 5 generates the intermediate image 17 based on the optical image 11, the mass spectrometry image 10, and the high-resolution mass spectrometry image 12.

In step 103i, the image processor 5 acquires the first coefficient 20. Specifically, the image processor 5 acquires the first coefficient 20 stored in the storage 7.

In step 103j, the image processor 5 multiplies the intermediate image 17 by the first coefficient 20. Accordingly, the image processor 5 generates the intermediate image 17a (see FIG. 7) multiplied by the first coefficient 20.

In step 103k, the image processor 5 subtracts the intermediate image 17a, which is multiplied by the first coefficient 20, from the high-resolution mass spectrometry image 12b. Accordingly, the image processor 5 generates the high-resolution mass spectrometry image 12c (see FIG. 7). In other words, the image processor 5 generates the high-resolution mass spectrometry image 12c based on the generated intermediate image 17 and the first coefficient 20.

In step 1031, the controller 6 determines whether an amount of changes of first pixel values, which is the pixel values of the high-resolution mass spectrometry image 12, is smaller than a threshold. If the amount of changes of the first pixel values is not smaller than the threshold, the procedure goes to step 103e. If the amount of changes of the first pixel values is smaller than the threshold, the procedure goes to step 104. In a case in which step 1031 is executed for the first time, because the first pixel values are not changed, determination whether an amount of changes of the first pixel values is smaller than the threshold value is not executed, and the procedure goes to step 103e.

Any one of a set of the processes in step 103a and step 103b, and a set of the processes in the step 103c and step 103d may be executed before another set. Also, the process in step 103i can be executed at any order as long as it is executed before the process in step 103j.

In the first embodiment, the image processor 5 repeats the steps 103e to 1031 as described above to reduce a difference between the first pixel value, which is one of the pixel values of the high-resolution mass spectrometry image 12, and the second pixel value, which is one of the pixel values of the mass spectrometry image 10. The adjustment of the variation amount of each pixel value of the mass spectrometry image 10 is executed by adjusting an amount of variation of the second pixel value when reducing the difference between the first pixel value and the second pixel value. The adjustment of the variation amount of each pixel value of the mass spectrometry image 10 is executed by adjusting the value of the first coefficient 20 or the value of the second coefficient 23. In the first embodiment, the adjustment of the variation amount of each pixel value of the mass spectrometry image 10 is executed by using the first coefficient 20.

### Advantages of First Embodiment

In the first embodiment, the following advantages are obtained.

In the first embodiment, as described above, an image processing method for a mass spectrometry image 10 includes a step of acquiring the mass spectrometry image 10 that is generated based on mass spectrometry data of a subject 90; a step of acquiring an optical image 11 that is generated by imaging the subject 90, the optical image having a higher resolution than the mass spectrometry image 10; and a step of generating a high-resolution mass spectrometry image 12 that is generated based on pixel values of the optical image 11, which has the higher resolution, and pixel values of the mass spectrometry image 10, which has a lower resolution, to improve the resolution of the mass spectrometry image, wherein the step of generating the high-resolution mass spectrometry image 12 includes adjusting a variation of each pixel value of the mass spectrometry image 10.

Accordingly, for example, when the high-resolution mass spectrometry image 12 is generated based on the mass spectrometry image 10, which includes superimposed noises, an amount of the superimposed noises included in the high-resolution mass spectrometry image 12 can be appropriately adjusted by adjusting a variation amount of each pixel value of the mass spectrometry image 10. Therefore, it is possible to adjust a noise amount while improving resolution in generation of a high-resolution mass spectrometry image 12, which has an improved resolution, based on a low-resolution mass spectrometry image 10 and a high-resolution optical image 11.

Also, in the first embodiment, as discussed above, an image processing method includes a step of acquiring a first image; a step of acquiring a second image that has a higher resolution than the first image; and a step of generating a third high-resolution image that is generated based on pixel values of the second image, which has the higher resolution, and pixel values of the first image, which has a lower resolution, to improve the resolution of the mass spectrometry image, wherein in the step of generating the third image, adjustment of a variation amount of each pixel value of the first image is executed.

Accordingly, similar to the image processing method for a mass spectrometry image 10 according to the aforementioned first embodiment, it is possible to provide an image processing method capable of adjusting a noise amount while improving resolution in generation of a high-resolution third image based on a low-resolution first image and a high-resolution second image.

Also, in the first embodiment, as discussed above, the mass spectrometry apparatus 100 includes a mass spectrometry image acquirer 3 configured to acquire a mass spectrometry image 10 that is generated based on mass spectrometry data of a subject 90; an optical image acquirer 4 configured to acquire an optical image 11 that is generated by imaging of the subject 90, the optical image having a higher resolution than the mass spectrometry image 10; and an image processor 5 configured to generate a high-resolution mass spectrometry image 12 that is generated based on pixel values of the optical image 11, which has the higher resolution, and pixel values of the mass spectrometry image 10, which has a lower resolution, to improve the resolution of the mass spectrometry image, wherein the image processor 5 is configured to adjust a variation amount of each pixel value of the mass spectrometry image 10 when generating the high-resolution mass spectrometry image 12.

Therefore, similar to the image processing method for a mass spectrometry image 10 according to the aforementioned first embodiment, it is possible to provide a mass spectrometry apparatus 100 capable of adjusting a noise amount while improving resolution in generation of a high-resolution mass spectrometry image 12, which has an improved resolution, based on a low-resolution mass spectrometry image 10 and a high-resolution optical image 11.

In addition, following additional advantages can be obtained by the aforementioned first embodiment added with configurations discussed below.

That is, in the first embodiment, as described above, a variation amount of each pixel value of the mass spectrometry image 10 is adjusted based on coefficients that are previously specified by a user and used to adjust a variation amount of each pixel value of the mass spectrometry image 10 in the adjustment of the variation amount of each pixel value of the mass spectrometry image 10. Consequently, the user can easily adjust the amount of variation of each pixel value of the mass spectrometry image 10 by previously specifying the coefficient.

In addition, the first embodiment, as discussed above, a step of accepting an entry of the coefficient(s) in accordance with an input instruction from the user is further provided, wherein a variation amount of each pixel value of the mass spectrometry image 10 is adjusted based on the coefficient that is accepted in accordance with an input instruction from the user in the adjustment of the variation amount of each pixel value of the mass spectrometry image 10. Accordingly, the user can adjust the amount of variation of each pixel value of the mass spectrometry image 10 by entering a desired coefficient depending on the mass spectrometry image 10. Consequently, in a case in which the amount of superimposed noises included in the mass spectrometry image 10 is large, the amount of the superimposed noises included in the high-resolution mass spectrometry image 12 can be reduced by increasing a variation amount of each pixel value of the mass spectrometry image 10. Also, for example, in a case in which the amount of superimposed noises included in the mass spectrometry image 10 is small, pixel values of the high-resolution mass spectrometry image 12 can be brought closer to pixel values of the mass spectrometry image 10 by reducing a variation amount of each pixel value of the mass spectrometry image 10. Accordingly, accuracy of pixel values of pixels of the high-resolution mass spectrometry image 12 can be improved. Because the user can easily adjust a variation amount of each pixel value of the mass spectrometry image 10 by entering a desired coefficient depending on the mass spectrometry image 10 in generation of the high-resolution mass spectrometry image 12, it is possible to improve user convenience (usability).

In addition, the first embodiment, as discussed above, a step of changing the coefficients that have been previously accepted in accordance with the input instruction from the user is further provided, wherein the variation amount of each pixel value of the mass spectrometry image 10 is adjusted based on the changed coefficients in the adjustment of the variation amount of each pixel value of the mass spectrometry image 10. In this configuration, the user can easily change a compound to be imaged as a mass spectrometry image 10 by changing a mass-to-charge ratio (m/z) in the mass spectrometry data of the measurement target area 90a of the subject 90. However, if the m/z is changed, superimposed noises included in the mass spectrometry image 10 also can change. For this reason, even when coefficients are suitable for adjustment of noises corresponding to a compound before m/z is changed, the coefficients may not be suitable for adjustment of noises corresponding to a compound after m/z is changed. To address this, according to the aforementioned configuration, even when the user changes a compound to be imaged as the mass spectrometry image 10 by changing m/z, the user can easily adjust a variation amount of each pixel value of the mass spectrometry image 10 after changing m/z by changing coefficients depending on the mass spectrometry image 10 after changing m/z. Because the user can easily adjust a variation amount of each pixel value of the mass spectrometry image 10 after changing m/z even when changing m/z to be imaged in the measurement target area 90a of the subject 90, it is possible to improve user convenience (usability).

In addition, the first embodiment, as discussed above, a difference between a first pixel value, which is one of the pixel values of the high-resolution mass spectrometry image 12, and a second pixel value, which is one of the pixel values of the mass spectrometry image 10 is repeatedly reduced in the step of generating the high-resolution mass spectrometry image 12; and the adjustment of the variation amount of each pixel value of the mass spectrometry image 10 is executed by adjusting an amount of variation of the second pixel value when reducing the difference between the first pixel value and the second pixel value. Accordingly, because an amount of variation of the second pixel value is adjusted when bringing the first pixel values of the high-resolution mass spectrometry image 12 closer to the second pixel values of the mass spectrometry image 10, for example, in a case in which the mass spectrometry image 10 includes superimposed noises, superimposed noises included in the high-resolution mass spectrometry image 12 can be reduced by increasing an amount of variation of each second pixel value. Also, for example, in a case in which the amount of superimposed noises included in the mass spectrometry image 10 is small, values of first pixel values of the high-resolution mass spectrometry image 12 can be brought closer to second pixel values, which are pixel values of the mass spectrometry image 10, by reducing an amount of variation of each second pixel value. Consequently, the user can easily adjust the amount of noises included in the high-resolution mass spectrometry image 12 and accuracy of first pixel values relative to the second pixel values by adjusting an amount of variation of each second pixel value depending on the amount of superimposed noises included in the mass spectrometry image 10.

In addition, the first embodiment, as discussed above, the coefficients include a first coefficient 20 that increases the variation amount of each second pixel values as a value of the first coefficient decreases, or a second coefficient 23 that increases the variation amount of each second pixel values as a value of the second coefficient increases; and the adjustment of the variation amount of each pixel value of the mass spectrometry image 10 is executed by adjusting the value of the first coefficient 20 or the value of the second coefficient 23. Consequently, the user can easily adjust the amount of variation of each pixel value of the mass spectrometry image 10 by adjusting a value of the first coefficient 20 or a value of the second coefficient 23.

In addition, the first embodiment, as discussed above, an intermediate image 17 is generated based on the optical image 11, the mass spectrometry image 10 and the high-resolution mass spectrometry image 12, and the high-resolution mass spectrometry image 12 is generated based on the generated intermediate image 17 and the first coefficient 20 in the step of generating the high-resolution mass spectrometry image 12; and the adjustment of the variation amount of each pixel value of the mass spectrometry image 10 is executed by using the first coefficient 20. Consequently, the user can easily adjust the amount of variation of each pixel value of the mass spectrometry image 10 by adjusting the first coefficient 20 when generating the high-resolution mass spectrometry image 12 based on the intermediate image 17 and the first coefficient 20.

### Second Embodiment

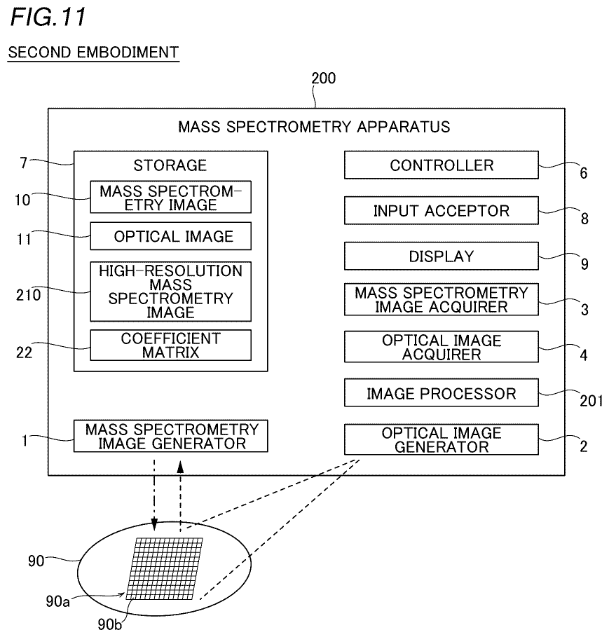

A mass spectrometry apparatus 200 (see FIG. 11) according to a second embodiment is now described with reference to FIGS. 11 to 13. Dissimilar to the mass spectrometry apparatus 100 according to the first embodiment, which adjusts a variation amount of each pixel value of the mass spectrometry image 10 (see FIG. 1) by using the first coefficient 20 (see FIG. 1), the following description describes a configuration of the mass spectrometry apparatus 200 according to the second embodiment that generates a high-resolution mass spectrometry image 210 without adjusting an amount of variation in each pixel value of the mass spectrometry image 10. The same configurations in the second embodiment as those of the first embodiment are denoted by the same reference numerals, and their description is omitted.

The mass spectrometry apparatus 200 according to the second embodiment includes an image processor 201, which is a different from the mass spectrometry apparatus 100 according to the first embodiment, instead of the image processor 5. Also, a storage 7 that is included in the mass spectrometry apparatus 200 according to the second embodiment is different from the storage 7 that is included in the first embodiment from the viewpoint that a coefficient matrix 22 is stored instead of the first coefficient 20.

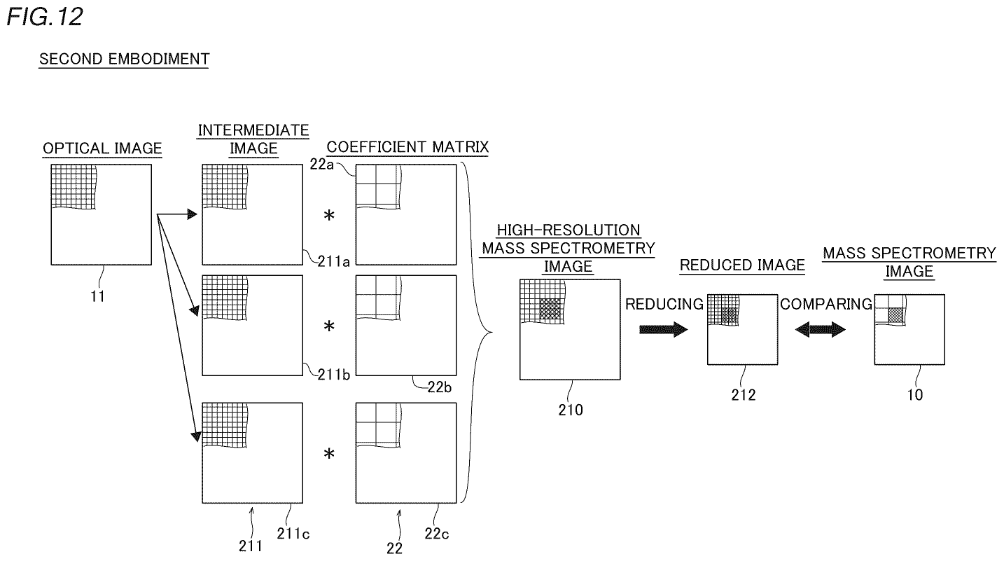

The image processor 201 is different from the image processor 5 in the first embodiment from the viewpoints that an intermediate image 211 (see FIG. 12) is generated based on the optical image 11, and that a high-resolution mass spectrometry image 210 is generated based on the optical image 11, which has the higher resolution, the intermediate image 211 and the mass spectrometry image 10, which has a lower resolution, to improve the resolution of the mass spectrometry image.

### (Generation of High-Resolution Mass Spectrometry Image)

A configuration of the image processor 201 (see FIG. 11) that generates the high-resolution mass spectrometry image 210 in the second embodiment is now described with reference to FIG. 12.

As shown in FIG. 12, the image processor 201 generates a plurality of intermediate images 211 based on the optical image 11. The intermediate images 211 are, for example, base images that correspond to colors and are extracted from the optical image 11. The intermediate image 211 can include a base image raised to the second or higher power, and a base image to which a filter is applied.

FIG. 12 is a schematic diagram illustrating exemplary generation of a first intermediate image 211a to an n-th intermediate image 211c as the intermediate images 211 generated by the image processor 201. A resolution of each intermediate image 211 is equal to a resolution of the optical image 11. That is, resolutions of the first intermediate image 211a to the n-th intermediate image 211c are equal to the resolution of the optical image 11. A resolution of one image equal to a resolution of another image means the number of pixels of the one image equal to the number of pixels of the another image.

In the second embodiment, the image processor 201 generates the high-resolution mass spectrometry image 210 based on the intermediate image 211 and the coefficient matrix 22, which is a matrix of a plurality of coefficients. The coefficient matrix 22 includes coefficients (parameters) the number of which is equal to or greater than the number of pixels of the mass spectrometry image 10. In the second embodiment, the coefficient matrix 22 includes coefficients (parameters) the number of which is equal to the number of pixels of the mass spectrometry image 10. In the second embodiment, the image processor 201 is configured to increase the coefficient matrix 22 to a resolution same as the intermediate image 211 by using image interpolation. A plurality of coefficient matrices are included as the coefficient matrix 22. Specifically, coefficient matrices the number of which is equal to the intermediate image 211 are included as the coefficient matrix 22. Accordingly, in the second embodiment, the coefficient matrix 22 includes the first coefficient matrix 22a to the n-th coefficient matrix 22c.

The image processor 201 generates the high-resolution mass spectrometry image 210 based on the intermediate images 211 and the coefficient matrices 22.

The intermediate images 211 are defined by the following Equation (1), and the coefficient matrices 22 are defined by the following Equation (2).

$$\begin{matrix}[ Equation 1 ] & \\ {X}_{k} = {\{ {x}_{ij}^{( k )} \}}_{k} ∈ {ℝ}^{{w}_{H R}} \times {ℝ}^{{h}_{H R}} , k = 1 , … , n & ( 1 )\end{matrix}$$

$${A}_{k} = {\{ {a}_{st}^{( k )} \}}_{k} ∈ {ℝ}^{{w}_{L R}} \times {ℝ}^{{h}_{L R}} , k = 1 , … , n \qquad ( 2 )$$

where i is a natural number from 1 to the number of pixels in a horizontal direction of the intermediate image 211, j is a natural number from 1 to the number of pixels in a vertical direction of the intermediate image 211, s is a natural number from 1 to the number of pixels in the horizontal direction of each coefficient matrix 22 (the number of pixels in the horizontal direction of the mass spectrometry image 10), and t is a natural number from 1 to the number of pixels in the vertical direction of each coefficient matrix 22 (the number of pixels in the vertical direction of the mass spectrometry image 10).

The image processor 201 calculates the products (Hadamard products) of pixels of the intermediate images 211 and the coefficients of their corresponding coefficient matrices 22, and adds the produces to generate the high-resolution mass spectrometry image 210. Because the resolution of the coefficient matrix 22 is equal to the mass spectrometry image 10, the Hadamard product of the coefficient matrix 22 and the intermediate image 211 cannot be directly calculated. To address this, in this embodiment, the coefficient matrix 22 is increased by an interpolation function for increasing an image defined by the following Equation (3).

$$\begin{matrix}[ Equation 2 ] & \\ ψ ( \cdot ) : {ℝ}^{{w}_{L R}} \times {ℝ}^{{h}_{L R}} \to {ℝ}^{{w}_{H R}} \times {ℝ}^{{h}_{H R}} & ( 3 )\end{matrix}$$

The increased coefficient matrix 22 can be represented by the following Equation (4).

$$\begin{matrix}[ Equation 3 ] & \\ {A}_{k}^{′} = ψ ( {A}_{k} ) = {\{ {a}_{ij}^{′ ( k )} \}}_{k} ∈ {ℝ}^{{w}_{H R}} \times {ℝ}^{{h}_{H R}} & ( 4 )\end{matrix}$$

Because the intermediate image 211 is an image generated based on the optical image 11, pixel values of pixels of the high-resolution mass spectrometry image 210 are different from pixel values of pixels of the mass spectrometry image 10. For this reason, the image processor 201 optimizes coefficients of each of the plurality of coefficient matrices 22 based on the mass spectrometry image 10 to bring pixel values of pixels of the high-resolution mass spectrometry image 210 closer to the pixel values of pixels of the mass spectrometry image 10.

Here, the mass spectrometry image 10 is defined by the following Equation (5), and the high-resolution mass spectrometry image 210 can be expressed by the following Equation (6).

$$\begin{matrix}[ Equation 4 ] & \\ Y = \{ {y}_{s t :} \} ∈ {ℝ}^{{W}_{L R}} \times {ℝ}^{{h}_{L R}} & ( 5 )\end{matrix}$$

$$\hat{Y} = {\sum }_{k = 1}^{n} ψ ( {A}_{k} ) * {X}_{k} = \{ {\hat{y}}_{i j} \} ∈ {ℝ}^{{w}_{H R}} \times {ℝ}^{{h}_{H R}} \qquad ( 6 )$$

By transforming Equation (6) based on Equation (1), Equation (2), and Equation (6), the high-resolution mass spectrometry image 210 can be expressed by the following Equation (7).

$$\begin{matrix}[ Equation 5 ] & \\ {\hat{y}}_{i j} = {\sum }_{k = 1}^{n} {a}_{ij}^{′ ( k )} {x}_{i j}^{( k )} & ( 7 )\end{matrix}$$

Because the resolution of the high-resolution mass spectrometry image 210 is higher than the mass spectrometry image 10, their pixel values cannot be directly compared with each other. For this reason, in this embodiment, the image processor 201 reduces the high-resolution mass spectrometry image 210 by using an image reduction function defined by the following Equation (8), and then compares pixel values of the reduced high-resolution mass spectrometry image 210 (reduced image 212) with pixel values of the mass spectrometry image 10.

$$\begin{matrix}[ Equation 6 ] & \\ φ ( \cdot ) : {ℝ}^{{w}_{H R}} \times {ℝ}^{{h}_{H R}} \to {ℝ}^{{w}_{L R}} \times {ℝ}^{{h}_{L R}} & ( 8 )\end{matrix}$$

Specifically, the image processor 201 acquires the coefficient matrix 22 that minimizes the following Equation (9) to bring pixel values of the high-resolution mass spectrometry image 210 close to pixel values of the mass spectrometry image 10.

$$\begin{matrix}[ Equation 7 ] & \\ f ( a ) = \frac{1}{2} {‖ φ ( \hat{Y} ) - Y ‖}^{2} + λ g ( a ) & ( 9 )\end{matrix}$$

where λ g(a) is a regularization term that avoids divergence of the solution of Equation (9). λ is a coefficient that is previously specified by the user and is stored in the storage 7. λ is a number greater than 0, for example.

In the second embodiment, the image processor 201 updates the coefficient matrix 22 to reduce differences between the pixel values of the high-resolution mass spectrometry image 210 and the pixel values of the mass spectrometry image 10. For example, the image processor 201 repeats a process of determining how much an error decreases after the coefficients are changed, and acquires the optimal coefficient matrix 22 by using gradient descent method.

Here, the optimal coefficient matrix 22 is defined by the following Equation (10), and the high-resolution mass spectrometry image 210 can be expressed by the following Equation (11).

$$\begin{matrix}[ Equation 8 ] & \\ {a}^{*} = arg min f ( a ) & ( 10 )\end{matrix}$$

$${\hat{Y} \vert}_{a = {a}^{*}} \qquad ( 11 )$$

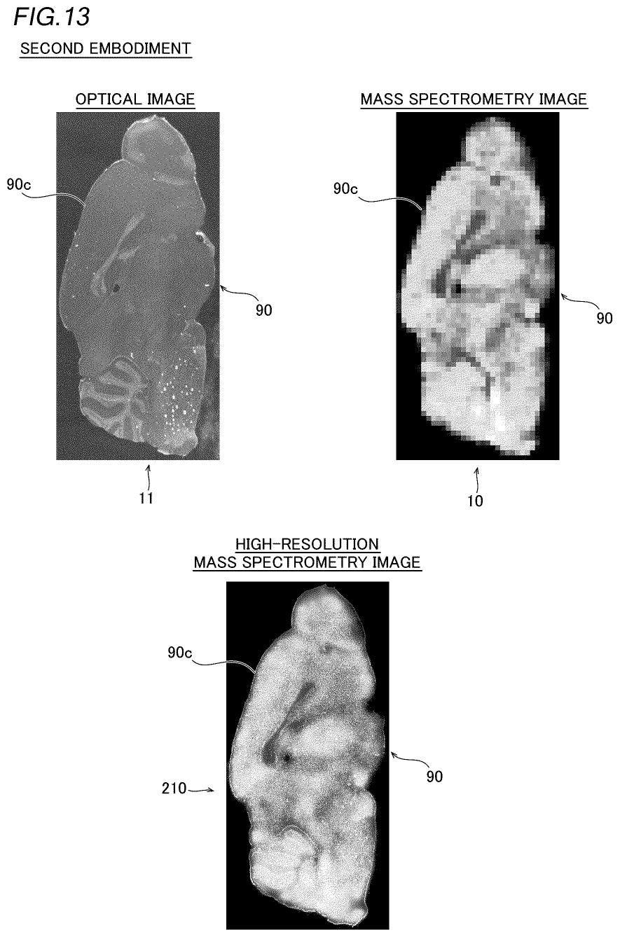

As shown in FIG. 13, the image processor 201 (see FIG. 11) generates the high-resolution mass spectrometry image 210 based on the optical image 11, which has the higher resolution, and the mass spectrometry image 10, which has a lower resolution, to improve the resolution of the mass spectrometry image. Although the mass spectrometry image 10 is illustratively shown in the same size as the optical image 11 and the high-resolution mass spectrometry image 210 in FIG. 13 for convenience, the size of the mass spectrometry image 10 is smaller than the optical image 11 and the high-resolution mass spectrometry image 210.

As shown in FIG. 13, because the resolution of the mass spectrometry image 10 is low, outlines 90c of the subject 90 are jagged like stairstep-like lines. Contrary to this, the resolution of the optical image 11 is high so that outlines 90c of the subject 90 are smooth. Outlines 90c of the subject 90 in the high-resolution mass spectrometry image 210 are also smooth similar to the outlines 90c of the subject 90 in the optical image 11.

The pixel values of pixels of the high-resolution mass spectrometry image 210 become substantially equal to the pixel values of pixels of the mass spectrometry image 10. That is, the pixel values of pixels of the mass spectrometry image 10 are reflected in the pixel values of pixels of the high-resolution mass spectrometry image 210. Consequently, it can be said that accuracy of the pixel values of pixels of the high-resolution mass spectrometry image 210 is high.

### (Generation Process of High-Resolution Mass Spectrometry Image)

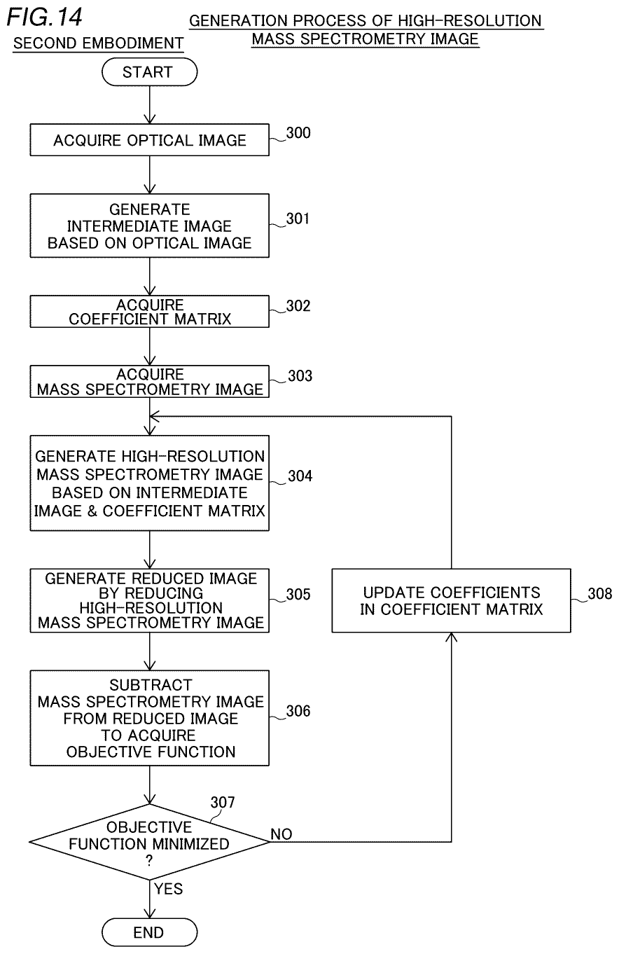

Generation process of the high-resolution mass spectrometry image 210 (see FIG. 13) by the mass spectrometry apparatus 200 (see FIG. 11) in the second embodiment is now described with reference to FIG. 14.

In step 300, the optical image acquirer 4 acquires the optical image 11 (see FIG. 13), which is generated by imaging the subject 90, imaging a higher resolution than the mass spectrometry image 10.

In step 301, the image processor 201 (see FIG. 11) generates the intermediate image 211 (see FIG. 12) based on the optical image 11.

In step 302, the image processor 201 acquires the coefficient matrix 22 (see FIG. 11). Specifically, the image processor 201 acquires the coefficient matrix 22 stored in the storage 7.

In step 303, the mass spectrometry image acquirer 3 acquires the mass spectrometry image 10 (see FIG. 13) generated based on the mass spectrometry data of the subject 90 (see FIG. 13).

In step 304, the image processor 201 generates the high-resolution mass spectrometry image 210 based on the generated intermediate image 211 and the coefficient matrix 22. In other words, the image processor 201 generates the high-resolution mass spectrometry image 210 based on the optical image 11, which has the higher resolution, the intermediate image 211, and the mass spectrometry image 10, which has a lower resolution, to improve the resolution of the mass spectrometry image.

In step 305, the image processor 201 generates the reduced image 212 (see FIG. 12) by reducing the high-resolution mass spectrometry image 210.

In step 306, the image processor 201 subtracts the mass spectrometry image 10 from the reduced image 212 to acquire an objective function represented by the aforementioned Equation (9).

In step 307, the controller 6 determines whether the objective function is minimized. If the objective function is minimized, the procedure ends. If the objective function is not minimized, procedure goes to step 308.

In step 308, the image processor 201 updates coefficients in the coefficient matrix 22. Subsequently, the procedure goes to step 304. In step 308, the image processor 201 update the coefficient matrix 22 to reduce differences between pixel values of the high-resolution mass spectrometry image 210 and pixel values of the mass spectrometry image 10.

In the second embodiment, as described above, the image processor 201 repeatedly executes a step (step 304) of generating the high-resolution mass spectrometry image 210 based on the intermediate image 211 and the coefficient matrix 22, which is a matrix of a plurality of coefficients, processes of steps 305 through 307, and a step (step 308) of updating the coefficient matrix 22 to reduce differences between the pixel values of the high-resolution mass spectrometry image 210 and the pixel values of the mass spectrometry image 10 to optimize the coefficient matrix 22. Specifically, the image processor repeatedly executes a step (step 304) of generating the high-resolution mass spectrometry image 210 by multiplying the generated intermediate image 211 by the coefficient matrix 22, which is a matrix of a plurality of coefficients, and a step (step 308) of updating the coefficient matrix 22 to reduce differences between the pixel values of the high-resolution mass spectrometry image 210 and the pixel values of the mass spectrometry image 10. The image processor 201 optimizes the coefficient matrix 22, and generates the high-resolution mass spectrometry image 210 based on the optimized coefficient matrix 22 and the intermediate image 211.

A process set of steps 300 and 301, a process of step 302, and a process of step 303 may be executed in any order.

The other configurations of the second embodiment are similar to the first embodiment.

### Advantages of Second Embodiment

In the second embodiment, the following advantages are obtained.

In the second embodiment, as described above, the method for processing a mass spectrometry image 10 includes a step of acquiring a mass spectrometry image 10 that is generated based on mass spectrometry data of a subject 90; a step of acquiring an optical image 11 that is generated by imaging the subject 90, the optical image having a higher resolution than the mass spectrometry image 10; and a step of generating an intermediate image 211 based on the optical image 11; a step of generating a high-resolution mass spectrometry image 210 that is generated based on the optical image 11, which has the higher resolution, the intermediate image 211, and pixel values of the mass spectrometry image 10, which has a lower resolution, to improve the resolution of the mass spectrometry image, wherein in the step of generating the high-resolution mass spectrometry image 210, a step of generating the high-resolution mass spectrometry image 210 based on the intermediate image 211 and a coefficient matrix 22, which is a matrix of a plurality of coefficients, and a step of updating the coefficient matrix 22 to reduce differences between the pixel values of the high-resolution mass spectrometry image 210 and the pixel values of the mass spectrometry image 10 are repeatedly executed to optimize the coefficient matrix 22, and the high-resolution mass spectrometry image 210 is generated based on the optimized coefficient matrix 22 and the intermediate image 211.

Here, in a case in which a high-resolution mass spectrometry image 210 is generated based on an intermediate image 211 and a single coefficient (scalar coefficient), the number of coefficients used for become smaller relative to the number of pixels of the mass spectrometry image 10. In this case, a system for determining coefficients becomes an overdetermined system including more equations than unknowns. In overdetermined systems, they generally have no solution so that locally some pixels whose pixel values cannot acquire will appear in the high-resolution mass spectrometry image 210 generated based on the mass spectrometry image 10. In this case, contrast of the high-resolution mass spectrometry image 210 is reduced. To address this, the high-resolution mass spectrometry image 210 is generated based on the intermediate image 211 and the coefficient matrix 22, and as a result the number of coefficients in the coefficient matrix 22 can be equal to the number of pixels in the mass spectrometry image 10. Accordingly, the pixel values of pixels of the high-resolution mass spectrometry image 210 can be acquired based on the mass spectrometry image 10 by adjusting the coefficients included in the coefficient matrix 22 Consequently, it is possible to prevent reduction of contrast of the high-resolution mass spectrometry image 210.

In addition, following additional advantages can be obtained by the aforementioned second embodiment added with configurations discussed below.

That is, in the second embodiment, as described above, a step of generating the high-resolution mass spectrometry image 210 by multiplying the generated intermediate image 211 by a coefficient matrix 22, which is a matrix of a plurality of coefficients, and a step of updating the coefficient matrix 22 to reduce differences between the pixel values of the high-resolution mass spectrometry image 210 and the pixel values of the mass spectrometry image 10 are repeatedly executed in the step of generating the high-resolution mass spectrometry image 210 Accordingly, it is possible to easily optimize coefficients included in the coefficient matrix 22. Consequently, it is possible to easily acquire the coefficient matrix 22 capable of preventing reduction of contrast of the high-resolution mass spectrometry image 210.

The other advantages of the second embodiment are similar to the first embodiment.

### Modified Embodiments

Note that the embodiment disclosed this time must be considered as illustrative in all points and not restrictive. The scope of the present invention is not shown by the above description of the embodiments but by the scope of claims for patent, and all modifications (modified example) within the meaning and scope equivalent to the scope of claims for patent are further included.

### Modified Example of Second Embodiment

While the example in which the image processor 201 does not adjust an amount of variation in each pixel value of the mass spectrometry image 10 has been shown in the aforementioned second embodiment, the present invention is not limited to this. For example, in a configuration in which a high-resolution mass spectrometry image 210 is generated by using a coefficient matrix 22, an image processor 401 is configured to adjust a variation amount of each pixel value of the mass spectrometry image 10 in a modified example of the second embodiment shown in FIG. 15.

As shown in FIG. 15, a mass spectrometry apparatus 400 according to the modified example of the second embodiment, which is a different from the mass spectrometry apparatus 200 according to the aforementioned second embodiment, includes an image processor 401 instead of the image processor 201.

The image processor 401 is different from the image processor 201 in the aforementioned second embodiment from viewpoint that the image processor 401 adjusts a variation amount of each pixel value of the mass spectrometry image 10 when generating the high-resolution mass spectrometry image 210. In addition, the storage 7 in the modified example of the second embodiment is different from the storage 7 in the aforementioned second embodiment from viewpoint that the storage 7 in the modified example stores the second coefficient 23, which will be described later.

The image processor 401 in the modified example of the second embodiment adjusts a variation amount of each pixel value of the mass spectrometry image 10 by adjusting a value of λ in the aforementioned Equation (9). That is, λ in the aforementioned Equation (9) is the second coefficient 23. In other words, in the modified example of the second embodiment, the adjustment of the variation amount of each pixel value of the mass spectrometry image 10 is executed by using the second coefficient 23.

The second coefficient 23 is greater than 0, and can more effectively prevent divergence of the solution of Equation (9) as a value of the second coefficient 23 increases. In other words, as the value of the second coefficient 23 increases, the amount of variation of each pixel value of the mass spectrometry image 10 increases.

The other configurations of the mass spectrometry apparatus 400 according to the modified example of the second embodiment are similar to the mass spectrometry apparatus 200 according to the aforementioned second embodiment.

### (Noise Adjustment of High-Resolution Mass Spectrometry Image)

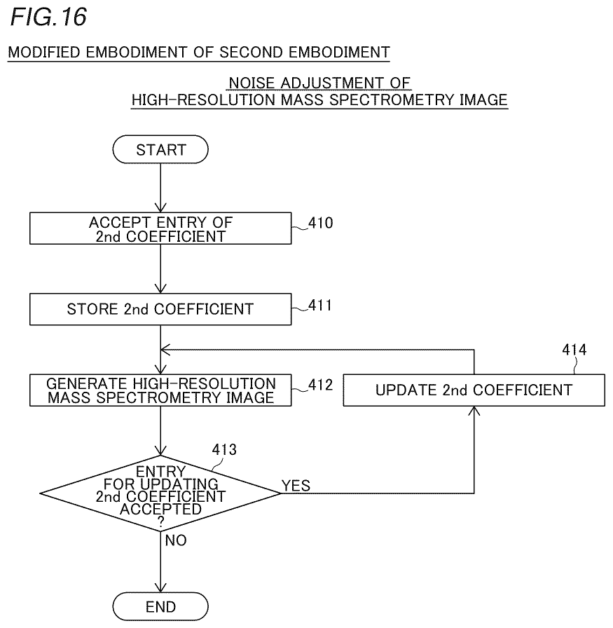

Adjustment of noises in the high-resolution mass spectrometry image 210 (see FIG. 15) by the image processor 401 (see FIG. 15) according to the modified example of the second embodiment is now described with reference to FIG. 16.

In step 410, the controller 6 (see FIG. 15) accepts an entry of the coefficients in accordance with an input instruction from the user. In the modified example of the second embodiment, the controller 6 accepts the entry of the second coefficient 23 (see FIG. 15).

In step 411, the controller 6 stores the second coefficient 23 into the storage 7 (see FIG. 15).

In step 412, the image processor 401 generates a high-resolution mass spectrometry image 210. Specifically, the image processor 401 generates the high-resolution mass spectrometry image 210 based on the generated intermediate image 211, the second coefficient 23 and the coefficient matrix 22 (see FIG. 15). Because a configuration of the image processor 401 that generates the high-resolution mass spectrometry image 210 in the modified example of the second embodiment is similar to the configuration of the image processor 201 (see FIG. 11) that generates the high-resolution mass spectrometry image 210 by executing steps 300 to 308 shown in FIG. 14 in the second embodiment except that the second coefficient 23 is used as the value of λ in the aforementioned Equation (9), its description is omitted.

In step 413, the controller 6 determines whether an entry for updating the coefficient is accepted. Specifically, the controller 6 determines whether an entry for updating the second coefficient 23 is accepted. If no entry for updating the second coefficient 23 is accepted, the procedure ends. If an entry for updating the second coefficient 23 is accepted, the procedure goes to step 414.

In step 414, the controller 6 changes a coefficient that is already entered to the coefficient that is entered by the user. Specifically, the controller 6 updates the second coefficient 23 stored in the storage 7 in accordance with a value entered by the user. Subsequently, the procedure goes to step 412.

As discussed above, the image processor 401 in the modified example of the second embodiment generates the high-resolution mass spectrometry image 210 based on a desired second coefficient 23 that is entered by the user by executing steps 410 to 414. Also, the image processor 401 adjusts an amount of variation in each pixel value of the mass spectrometry image 10. Specifically, the image processor 401 adjusts an amount of variation in each pixel value of the mass spectrometry image 10 by using the second coefficient 23. In step 412 after the second coefficient 23 is changed (updated), because the high-resolution mass spectrometry image 210 is generated by using the changed second coefficient 23, the image processor 401 adjusts the amount of variation of each pixel value of the mass spectrometry image 10 based on the changed second coefficient 23.

The other configurations of the modified example of the second embodiment are similar to the aforementioned second embodiment.

In the modified example of the second embodiment, as discussed above, an intermediate image 211 is generated based on the optical image 11, and the high-resolution mass spectrometry image 210 is generated based on the generated intermediate image 211 and the second coefficient 23 in the step of generating the high-resolution mass spectrometry image 210; and the adjustment of the variation amount of each pixel value of the mass spectrometry image 10 is executed by using the second coefficient 23. Consequently, the user can easily adjust the amount of variation of each pixel value of the mass spectrometry image 10 by adjusting the second coefficient 23 when generating the high-resolution mass spectrometry image 210 based on the intermediate image 211 and the second coefficient 23.

The other advantages of the modified example of the second embodiment are similar to the aforementioned second embodiment.

While the example in which the image processor 401 adjusts a variation amount of each pixel value of the mass spectrometry image 10 by adjusting a value of λ as the second coefficient 23 in the aforementioned Equation (9) has been shown in the aforementioned modified example of the second embodiment, the present invention is not limited to this. For example, the image processor may be configured to adjust a variation amount of each pixel value of the mass spectrometry image 10 by adjusting a value of α in the following Equation (12).

### [Equation 9]

### Other Modified Embodiments

While the example in which the image processor 5 (image processor 401) adjusts an amount of variation of each pixel value of the mass spectrometric image 10 based on a predetermined coefficient (first coefficient 20 or second coefficient 23) previously specified by a user has been shown in the aforementioned first embodiment and the aforementioned modified example of the second embodiment, the present invention is not limited to this. For example, the image processor may be configured to adjust a variation amount of each pixel value of the mass spectrometric image 10 based on an intrinsic coefficient that is not specified by users. However, in a case of a configuration in which a variation amount of each pixel value of the mass spectrometric image 10 is adjusted based on an intrinsic coefficient that is not specified by users, the users cannot make adjustment to a desired value. For this reason, the image processor is preferably configured to adjust a variation amount of each pixel value of the mass spectrometric image 10 based on a coefficient that is previously specified by a user.

While the example in which the image processor 5 (image processor 401) adjusts a variation amount of each pixel value of the mass spectrometric image 10 based on a coefficient (first coefficient 20 or second coefficient 23) that is previously entered by a user has been shown in the aforementioned first embodiment and the aforementioned modified example of the second embodiment, the present invention is not limited to this. For example, the image processor may be configured to adjust a variation amount of each pixel value of the mass spectrometric image 10 based on a coefficient that previously specified by a user not by entering the coefficient. However, in a case of a configuration in which a variation amount of each pixel value of the mass spectrometric image 10 is adjusted based on a coefficient that previously specified by a user, the user cannot adjust a variation amount of each pixel value of the mass spectrometric image 10 based on a coefficient suitable for the mass spectrometry image 10. In this case, the user cannot make desired noise adjustment depending on the mass spectrometry image 10. For this reason, the image processor is preferably configured to adjust a variation amount of each pixel value of the mass spectrometric image 10 based on a coefficient that is entered by a user.

While the example in which the mass spectrometry apparatus 100 (mass spectrometry apparatus 200) includes the optical image generator 2 has been shown in the aforementioned first and second embodiments, the present invention is not limited to this. For example, the mass spectrometry apparatus may not include the optical image generator 2. In this case, the mass spectrometry apparatus can be configured to acquire the optical image 11 that is generated by a microscope installed separately from the mass spectrometry apparatus through the optical image acquirer 4.

While the example in which the mass spectrometry apparatus 100 (mass spectrometry apparatus 200) generates the high-resolution mass spectrometry image 12 (high-resolution mass spectrometry image 210) has been shown in the aforementioned first and second embodiments, the present invention is not limited to this. For example, the high-resolution mass spectrometry image may be generated by a computer including the image processor. That is, the mass spectrometry image processing method in the aforementioned first and second embodiments may be performed by a computer including the image processor.

While the example in which the image processor 5 repeats the process 40 and the process 41 until an amount of change in each pixel value of the high-resolution mass spectrometry image 12 becomes smaller than a threshold has been shown in the aforementioned first embodiment, the present invention is not limited to this. For example, the image processor may be configured to repeat the process 40 and the process 41 a number of times that is specified by a user.

While the example in which the number of coefficients included in the coefficient matrix 22 is equal to the number of pixels of the mass spectrometry image 10 has been shown in the aforementioned second embodiment, the present invention is not limited to this. The number of coefficients included in the coefficient matrix 22 can be any number not smaller than the number of pixels of the mass spectrometry image 10.

In this specification, the first embodiment and the second embodiment are described as different embodiments from each other, but the present invention is not limited to this. For example, the mass spectrometry apparatus may include a configuration configured by combining the first embodiment and the second embodiment.

While the example in which the first image is the mass spectrometry image 10, the second image is the optical image 11, and the third image is the high-resolution mass spectrometry image 12 (high-resolution mass spectrometry image 210) has been shown in the aforementioned first and second embodiments, the present invention is not limited to this. For example, the first image may be a CT (computed Tomography) image, the second image may be an MRI (Magnetic Resonance Imaging) image having a higher resolution than the CT image, and the third image may be a high resolution CT image that has a resolution improved from the CT image. The first, second, and third images may be any images as long as a third image can be generated to bring its pixel values closer to pixel values of a first image that has a lower resolution based on the first image and a second image that has a higher resolution by applying a structure of the second image (for example, information on the outlines 90c of the subject 90) to improve a resolution of the third image.

### Modes

The aforementioned exemplary embodiment will be understood as concrete examples of the following modes by those skilled in the art.

### (Mode Item 1)

A mass spectrometry image processing method according to mode item 1 includes a step of acquiring a mass spectrometry image that is generated based on mass spectrometry data of a subject; a step of acquiring an optical image that is generated by imaging the subject, the optical image having a higher resolution than the mass spectrometry image; and a step of generating a high-resolution mass spectrometry image that is generated based on pixel values of the optical image, which has the higher resolution, and pixel values of the mass spectrometry image, which has a lower resolution, to improve the resolution of the mass spectrometry image, wherein the step of generating the high-resolution mass spectrometry image includes adjusting a variation of each pixel value of the mass spectrometry image.

### (Mode Item 2)

In the mass spectrometry image processing method according to mode item 1, the variation amount of each pixel value of the mass spectrometry image is adjusted based on a coefficient(s) that is/are previously specified by a user and used to adjust the variation amount of each pixel value of the mass spectrometry image in the adjustment of the variation amount of each pixel value of the mass spectrometry image.

### (Mode Item 3)

In the mass spectrometry image processing method according to mode item 2, a step of accepting an entry of the coefficient(s) in accordance with an input instruction from the user is further provided, wherein the variation amount of each pixel value of the mass spectrometry image is adjusted based on the coefficient that is accepted in accordance with the input instruction from the user in the adjustment of the variation amount of each pixel value of the mass spectrometry image.

### (Mode Item 4)

In the mass spectrometry image processing method according to mode item 3, a step of changing the coefficient(s) that has/have been previously accepted in accordance with the input instruction from the user is further provided, wherein the variation amount of each pixel value of the mass spectrometry image is adjusted based on the changed coefficient(s) in the adjustment of the variation amount of each pixel value of the mass spectrometry image.

### (Mode Item 5)

In the mass spectrometry image processing method according to mode item 4, differences between first pixel values, which are the pixel values of the high-resolution mass spectrometry image, and second pixel values, which are the pixel values of the mass spectrometry image, are repeatedly reduced in the step of generating the high-resolution mass spectrometry image; and the adjustment of a variation amount of each pixel value of the mass spectrometry image is executed by adjusting an amount of variation of the second pixel value when reducing the difference between the first pixel value and the second pixel value.

### (Mode Item 6)

In the mass spectrometry image processing method according to mode item 5, the coefficient(s) includes/include a first coefficient that increases the variation amount of each second pixel value as a value of the first coefficient decreases, or a second coefficient that increases the variation amount of each second pixel value as a value of the second coefficient increases; and the adjustment of a variation amount of each pixel value of the mass spectrometry image is executed by adjusting the value of the first coefficient or the value of the second coefficient.

### (Mode Item 7)

In the mass spectrometry image processing method according to mode item 6, an intermediate image is generated based on the optical image, the mass spectrometry image and the high-resolution mass spectrometry image, and the high-resolution mass spectrometry image is generated based on the generated intermediate image and the first coefficient in the step of generating the high-resolution mass spectrometry image; and the adjustment of a variation amount of each pixel value of the mass spectrometry image is executed by using the first coefficient.

### (Mode Item 8)

In the mass spectrometry image processing method according to mode item 6, an intermediate image is generated based on the optical image, and the high-resolution mass spectrometry image is generated based on the generated intermediate image and second coefficient in the step of generating the high-resolution mass spectrometry image; and the adjustment of a variation amount of each pixel value of the mass spectrometry image is executed by using the second coefficient.

### (Mode Item 9)

In the mass spectrometry image processing method according to mode item 8, a step of generating the high-resolution mass spectrometry image by multiplying the generated intermediate image by a coefficient matrix, which is a matrix of a plurality of coefficients as the coefficient(s), and a step of updating the coefficient matrix to reduce differences between the pixel values of the high-resolution mass spectrometry image and the pixel values of the mass spectrometry image are repeatedly executed in the step of generating the high-resolution mass spectrometry image.

### (Mode Item 10)

An image processing method according to mode item 10 includes a step of acquiring a first image; a step of acquiring a second image that has a higher resolution than the first image; and a step of generating a third high-resolution image that is generated based on pixel values of the second image, which has the higher resolution, and pixel values of the first image, which has a lower resolution, wherein in the step of generating the third image, adjustment of a variation amount of each pixel value of the first image is executed.

### (Mode Item 11)

A mass spectrometry apparatus according to mode item 11 includes a mass spectrometry image acquirer configured to acquire a mass spectrometry image that is generated based on mass spectrometry data of a subject; an optical image acquirer configured to acquire an optical image that is generated by imaging the subject, the optical image having a higher resolution than the mass spectrometry image; and an image processor configured to generate a high-resolution mass spectrometry image that is generated based on pixel values of the optical image, which has the higher resolution, and pixel values of the mass spectrometry image, which has a lower resolution, to improve the resolution of the mass spectrometry image, wherein the image processor is configured to adjust a variation amount of each pixel value of the mass spectrometry image when generating the high-resolution mass spectrometry image.

### (Mode Item 12)

A mass spectrometry image processing method according to mode item 12 includes a step of acquiring a mass spectrometry image that is generated based on mass spectrometry data of a subject; a step of acquiring an optical image that is generated by imaging the subject, the optical image having a higher resolution than the mass spectrometry image; and a step of generating an intermediate image based on the optical image; and a step of generating a high-resolution mass spectrometry image that is generated based on the optical image, which has the higher resolution, the intermediate image, and the mass spectrometry image, which has a lower resolution, to improve the resolution of the mass spectrometry image, wherein in the step of generating the high-resolution mass spectrometry image, a step of generating the high-resolution mass spectrometry image based on the intermediate image and a coefficient matrix, which is a matrix of a plurality of coefficients, and a step of updating the coefficient matrix to reduce differences between the pixel values of the high-resolution mass spectrometry image and the pixel values of the mass spectrometry image are repeatedly executed to optimize the coefficient matrix, and the high-resolution mass spectrometry image is generated based on the optimized coefficient matrix and the intermediate image.

What is claimed is:

1. A mass spectrometry image processing method comprising:
a step of acquiring a mass spectrometry image that is generated based on mass spectrometry data of a subject;
a step of acquiring an optical image that is generated by imaging the subject, the optical image having a higher resolution than the mass spectrometry image; and
a step of generating a high-resolution mass spectrometry image that is generated based on pixel values of the optical image, which has the higher resolution, and pixel values of the mass spectrometry image, which has a lower resolution, to improve the resolution of the mass spectrometry image, wherein
the step of generating the high-resolution mass spectrometry image includes adjusting a variation of each pixel value of the mass spectrometry image.

2. The mass spectrometry image processing method according to claim 1, wherein the variation amount of each pixel value of the mass spectrometry image is adjusted based on a coefficient(s) that is/are previously specified by a user and used to adjust the variation amount of each pixel value of the mass spectrometry image in the adjustment of the variation amount of each pixel value of the mass spectrometry image.

3. The mass spectrometry image processing method according to claim 2 further comprising a step of accepting an entry of the coefficient(s) in accordance with an input instruction from the user, wherein
the variation amount of each pixel value of the mass spectrometry image is adjusted based on the coefficient that is accepted in accordance with the input instruction from the user in the adjustment of the variation amount of each pixel value of the mass spectrometry image.

4. The mass spectrometry image processing method according to claim 3 further comprising a step of changing the coefficient(s) that has/have been previously accepted in accordance with the input instruction from the user, wherein
the variation amount of each pixel value of the mass spectrometry image is adjusted based on the changed coefficient(s) in the adjustment of the variation amount of each pixel value of the mass spectrometry image.

5. The mass spectrometry image processing method according to claim 4, wherein
differences between first pixel values, which are the pixel values of the high-resolution mass spectrometry image, and second pixel values, which are the pixel values of the mass spectrometry image, are repeatedly reduced in the step of generating the high-resolution mass spectrometry image; and
the adjustment of a variation amount of each pixel value of the mass spectrometry image is executed by adjusting an amount of variation of each second pixel value when reducing the difference between the first pixel value and the second pixel value.

6. The mass spectrometry image processing method according to claim 5, wherein
the coefficient(s) includes/include a first coefficient that increases the variation amount of each second pixel value as a value of the first coefficient decreases, or a second coefficient that increases the variation amount of each second pixel value as a value of the second coefficient increases; and
the adjustment of a variation amount of each pixel value of the mass spectrometry image is executed by adjusting the value of the first coefficient or the value of the second coefficient.

7. The mass spectrometry image processing method according to claim 6, wherein
an intermediate image is generated based on the optical image, the mass spectrometry image and the high-resolution mass spectrometry image, and the high-resolution mass spectrometry image is generated based on the generated intermediate image and the first coefficient in the step of generating the high-resolution mass spectrometry image; and
the adjustment of a variation amount of each pixel value of the mass spectrometry image is executed by using the first coefficient.

8. The mass spectrometry image processing method according to claim 6, wherein
an intermediate image is generated based on the optical image, and the high-resolution mass spectrometry image is generated based on the generated intermediate image and second coefficient in the step of generating the high-resolution mass spectrometry image; and
the adjustment of a variation amount of each pixel value of the mass spectrometry image is executed by using the second coefficient.

9. The mass spectrometry image processing method according to claim 8, wherein a step of generating the high-resolution mass spectrometry image by multiplying the generated intermediate image by a coefficient matrix, which is a matrix of a plurality of coefficients as the coefficient(s), and a step of updating the coefficient matrix to reduce differences between the pixel values of the high-resolution mass spectrometry image and the pixel values of the mass spectrometry image are repeatedly executed in the step of generating the high-resolution mass spectrometry image.

10. A image processing method comprising:
a step of acquiring a first image;
a step of acquiring a second image that has a higher resolution than the first image; and
a step of generating a third high-resolution image that is generated based on pixel values of the second image, which has the higher resolution, and pixel values of the first image, which has a lower resolution, wherein
in the step of generating the third image, adjustment of a variation amount of each pixel value of the first image is executed.

11. A mass spectrometry apparatus comprising:
a mass spectrometry image acquirer configured to acquire a mass spectrometry image that is generated based on mass spectrometry data of a subject;
an optical image acquirer configured to acquire an optical image that is generated by imaging the subject, the optical image having a higher resolution than the mass spectrometry image; and
an image processor configured to generate a high-resolution mass spectrometry image that is generated based on pixel values of the optical image, which has the higher resolution, and pixel values of the mass spectrometry image, which has a lower resolution, to improve the resolution of the mass spectrometry image, wherein
the image processor is configured to adjust a variation amount of each pixel value of the mass spectrometry image when generating the high-resolution mass spectrometry image.

12. A mass spectrometry image processing method comprising:
a step of acquiring a mass spectrometry image that is generated based on mass spectrometry data of a subject;
a step of acquiring an optical image that is generated by imaging the subject, the optical image having a higher resolution than the mass spectrometry image; and
a step of generating an intermediate image based on the optical image; and
a step of generating a high-resolution mass spectrometry image that is generated based on the optical image, which has the higher resolution, the intermediate image, and the mass spectrometry image, which has a lower resolution, to improve the resolution of the mass spectrometry image, wherein
in the step of generating the high-resolution mass spectrometry image, a step of generating the high-resolution mass spectrometry image based on the intermediate image and a coefficient matrix, which is a matrix of a plurality of coefficients, and a step of updating the coefficient matrix to reduce differences between the pixel values of the high-resolution mass spectrometry image and the pixel values of the mass spectrometry image are repeatedly executed to optimize the coefficient matrix, and the high-resolution mass spectrometry image is generated based on the optimized coefficient matrix and the intermediate image.
